(19) United States
(12) Patent Application Publication
(10) Pub. No.: US 2020/0167800 A1
(43) Pub. Date: May 28, 2020

(54) GRAPHICAL USER INTERFACE (GUI) WITHIN CRM SOLUTION ENABLING USER-DEFINED RULES FOR CONNECTED DEVICES

(71) Applicant: MapAnything, Inc., Charlotte, NC (US)

(72) Inventors: John Brian STEWART, Charlotte, NC (US); Benjamin Louis BRANTLY, Decatur, GA (US); Brian Kenneth HUBBARD, Sandy Springs, GA (US); Alexander Levi DANIELS, Charlotte, NC (US); Justine Lee HORITSKI, Charlotte, NC (US); Michael Christopher BROWN, Charlotte, NC (US); Abraham Javier REYES, Lawrenceville, GA (US)

(73) Assignee: MapAnything, Inc., Charlotte, NC (US)

(21) Appl. No.: 16/779,062

(22) Filed: Jan. 31, 2020

Related U.S. Application Data
(63) Continuation of application No. 15/784,069, filed on Oct. 13, 2017.
(60) Provisional application No. 62/407,579, filed on Oct. 13, 2016.

(51) Int. Cl. G06Q 30/00; G06N 5/04; G06T 11/20; G06F 3/0481; G06Q 10/06; G06N 5/02

(52) U.S. Cl. CPC G06Q 30/016; G06N 5/046; G06T 11/206; G06F 3/0481; H04L 67/02; G06Q 10/063; G06N 5/027; G06F 2203/04803; G06Q 30/018

(57) ABSTRACT

A computer-implemented method includes the step of providing a graphical user interface (GUI) that is accessible by users within a customer relationship management (CRM) solution. The GUI enables the users to define rules with each rule including one or more conditions and one or more associated actions to be taken upon the meeting of the one or more conditions. The method further includes receiving from a user via the GUI one or more user-defined rules; storing in non-transitory computer readable medium each received user-defined rule for later retrieval and processing; electronically receiving geospatial data acquired by a plurality of connected devices; identifying stored rules applicable to the received data; retrieving the identified rules; applying the rules to the received data; and taking the one or more actions of each retrieved rule upon the one or more conditions of the retrieved rule being met based on the received data.

### CROSS-REFERENCE TO RELATED APPLICATION

This patent document is a continuation of and claims priority to U.S. patent application Ser. No. 15/784,069 by Stewart et al., filed on Oct. 13, 2017, entitled, “GRAPHICAL USER INTERFACE (GUI) WITHIN CRM SOLUTION ENABLING USER-DEFINED RULES FOR CONNECTED DEVICES,” which claims priority to U.S. Provisional Patent Appl. No. 62/407,579, filed Oct. 13, 2016. Both U.S. patent application Ser. No. 15/784,069 and U.S. Provisional Patent Appl. No. 62/407,579 are hereby incorporated by reference in their entirety and for all purposes.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to systems in which rules are user-defined with respect to assets and, more particularly, to customer relationship management technology solutions in which a graphical user interface is provided for defining such rules by users, including event-based and geospatial rules regarding assets.

Customer relationship management (CRM) technology solutions are well known, with perhaps the leading CRM computer system currently being provided by Salesforce.com Inc., whose solution enables a business to store and manage prospect and customer information-such as contact information, accounts, cases, work orders, leads, and sales opportunities—in a single online platform, i.e., in “the cloud”, whereby the CRM solution easily scales and provides access to a user having a networked device when needed, wherever located, so long as there is network connectivity.

In conjunction with this technology solution, Salesforce.com Inc. also provides application program interfaces (APIs) to the Salesforce CRM computer system, thereby enabling independent third-party software developers to create applications that enable businesses to further leverage and make use of the Salesforce CRM computer system. Indeed, Salesforce.com Inc. provides a marketplace that facilitates the marketing of such applications by such developers.

One such developer is MapAnything. Inc., which has developed and offers one or more applications that fully integrate with the Salesforce CRM computer system and that enable users to map leads, contacts, and accounts based on geographical locations. The offering also utilizes geocoding, which is a feature that allows information to be obtained in real-time based on geographical location, and that can be used to assign cases to service professionals within a particular locale; to reallocate business resources to areas needing them most, providing solutions to problems as they arise; and to launch marketing campaigns based on target demographics in relevant geographical areas. In addition to being able to obtain real time information, the offering enables display of all relevant data, including both custom and standard objects, which can be saved and displayed within the Salesforce CRM solution as map overlays.

Even in view of the foregoing advancements, it is believed that one or more needs remain for continued improvement in CRM technology solutions. This, and other needs, are addressed by one or more aspects and features of the present invention.

### SUMMARY OF THE INVENTION

The present invention includes many aspects and features. Moreover, while many aspects and features relate to, and are described in, the context of CRM systems, the present invention is not limited to use only in such systems and will find utility in more general telematics and asset-tracking applications, such as fleet management solutions, as will become apparent from the following summaries and detailed descriptions of aspects, features, and one or more embodiments of the present invention.

Accordingly, one aspect of the present invention relates to a computer system in which users define rules, each rule comprising one or more conditions of the rule and one or more actions of the rule to be taken upon satisfaction of the one or more conditions. A rule may be an event-based rule and, preferably, is a geospatial rule. In accordance with this aspect, the computer system comprises hardware and software that are configured together to provide both a CRM computer system; and a rules-based computer system. The hardware of the CRM computer system preferably comprises one or more web servers running software, such as the Salesforce CRM platform, which provides the CRM solution to business users as well as provides a software platform enabling other third-party applications to run in an integrated manner seamlessly with the CRM solution. The hardware of the rules-based system also preferably comprises web servers running software that provides electronic communication capabilities, including the ability to receive and collect data from connected devices and providers of connected devices; electronic data storage capabilities; serves as a rules engine; and serves as an events manager, all as further disclosed hereinafter. The rules engine preferably collects, stores, analyzes, and acts on the data that is received, per the user-defined rules that are created. Moreover, in collecting the data, the rules engine preferably normalizes the data, especially since the data may be acquired from a plurality of connected devices of different vendors, wherein the data structure/format may differ greatly in the information that is received from the different connected devices. Acquisition of the data by the engine may be by push, null, or direct communication. The engine also preferably enriches the data. For example, when location information is received for a vehicle that is traveling, the data may be supplemented by the engine with the applicable posted speed limit at that location. Time and date information further may be normalized relative to a particular timezone.

In accordance with this aspect, the CRM computer system is accessible by users at a first set of one or more network IP addresses and provides access by the business users to a graphical user interface (GUI) by which the users define rules. Furthermore, the GUI comprises one or more windows, pages, or the like, each comprising one or more GUI controls by which each rule is defined by the user to comprise both one or more conditions, and one or more associated actions to be taken upon the meeting of the one or more conditions.

In further accordance with this aspect, the rules-based computer system is accessible at a second set of one or more network IP addresses different from the first set of network IP addresses, whereby the CRM computer system and the rules-based computer system are configured for electronic communications with one another, and whereby the rules-based computer system is configured to receive data acquired by a plurality of connected devices. The data preferably comprises geospatial data. The rules-based computer system additionally is configured to (A) electronically receive over the Internet from the CRM computer system, and store in non-transitory computer-readable medium, rules defined by the users using the GUI: (B) apply user-defined rules stored in the non-transitory computer-readable medium to the received data acquired by the plurality of connected devices; and (C) take the one or more actions of each user-defined rule upon the one or more conditions of the rule being met.

In a feature of this aspect, the CRM computer system is accessible by users over the Internet at the first set of network IP addresses.

In a feature of this aspect, the geospatial rules-based computer system is accessible over the Internet at the second set of network IP addresses.

In a feature of this aspect, each user-defined rule is electronically communicated from the CRM computer system to the rules-based computer system for storing and processing.

In a feature of this aspect, the data acquired by the connected devices comprises geospatial data of mobile phones.

In a feature of this aspect, the data acquired by the connected devices comprises geospatial data of smartphones.

In a feature of this aspect, the data acquired by the connected devices comprises geospatial data of tablets.

In a feature of this aspect, the data acquired by the connected devices comprises geospatial data of Android and iOS devices.

In a feature of this aspect, the data acquired by the connected devices comprises geospatial data of vehicles.

In a feature of this aspect, the data acquired by the connected devices comprises geospatial data of telematic devices. The telematic devices may be attached to vehicles; to shipping containers; and to both vehicles and shipping containers.

In a feature of this aspect, the rules-based computer system is configured to receive geospatial data acquired by the connected devices from connected devices.

In a feature of this aspect, the rules-based computer system is configured to receive geospatial data acquired by the connected devices from connected devices via Satellite communications.

In a feature of this aspect, the rules-based computer system is configured to receive geospatial data acquired by the connected devices from connected devices via cellular telecommunications.

In a feature of this aspect, the rules-based computer system is configured to receive geospatial data acquired by the connected devices from connected devices via wireless telecommunications.

In a feature of this aspect, the rules-based computer system is configured to receive geospatial data acquired by the connected devices from one or more gateways that receive the geospatial data of connected devices from the connected devices.

In a feature of this aspect, the rules-based computer system is configured to electronically communicate with the one or more gateways over the Internet.

In a feature of this aspect, the rules-based computer system is configured to process incoming data of the connected devices against one or more stored user-defined rules to determine if the one or more conditions are met of each of the one or more user-defined rules. The rules-based computer system is configured to take the one or more actions of a user-defined rule upon determining that the one or more conditions of the user-defined rule are met. In examples, the one or more conditions of a user-defined rule are met upon a connected device entering an area represented by a geofence that is specified in the user-defined rule; upon a connected device leaving an area represented by a geofence that is specified in the user-defined rule: or upon a connected device remaining for a predetermined time within an area represented by a geofence that is specified in the user-defined rule. The incoming data preferably comprises geospatial data, and the one or more actions of a user-defined rule that are taken by the rules-based computer system upon determining that the one or more conditions of the user-defined rule are met may comprise, for example: sending an alert regarding noncompliance with safety regulations that is determined by the rules-based computer system to have occurred; sending an alert regarding a malfunction that is determined by the rules-based computer system to have occurred: sending an email; sending an SMS message; sending a report for a sales rep to a manager of the sales rep with activity including mileage and hours worked; providing an alert regarding vehicle starts and stops; providing an alert regarding a deviation of a traveling asset from an assigned route; providing an alert to a customer regarding a changed estimated-time-of-arrival of an asset traveling to the customer based on real-time traffic conditions and real-time location of the asset; providing an alert to a customer upon an arrival of an asset at a location of the customer, sending a communication via an organizational communication tool; sending a communication via Salesforce Chatter: and adding a record to the CRM computer system by the rules-based computer system. In further respect to this, the rules-based computer system may be configured to send an http communication to the CRM computer system to affect the addition of a record to the CRM computer system, the change in a record of the CRM computer system, the retrieval of a record in the CRM computer system, or deletion of a record in the CRM computer system, which http communication may be RESTful.

In a feature of this aspect, the GUI is generated in accordance with a program that integrates with an application that provides a base functionality of the CRM computer system. The program that generates the GUI may represent an optional feature of the CRM computer system, and the program that generates the GUI may be provided by a first party that maintains the rules-based computer system, wherein the application that provides the base functionality of the CRM computer system may be maintained by another party unaffiliated with the first party.

In a feature of this aspect, the business users are customers of a provider of the CRM computer system. The CRM computer system may be provided to the users under a subscription with the provider of the CRM computer system, the users also may be customers of a provider of the rules-based computer system, and the rules-based computer system may be provided to the users under an additional subscription with the provider of the CRM computer system.

In a feature of this aspect, a provider of the CRM computer system is a customer of a provider of the rules-based computer system.

In a feature of this aspect, the GUI comprises a map-based graphical user interface.

In a feature of this aspect, the GUI further comprises one or more GUI controls by which an identification of a vendor of a connected device is specified for each user-defined rule.

In a feature of this aspect, the GUI further comprises one or more GUI controls by which an identification of a type of a connected device is specified for each user-defined rule, and

In a feature of this aspect, the GUI further comprises one or more GUI controls by which an identification of a connected device is specified for each user-defined rule;

In a feature of this aspect, the CRM computer system and the rules-based computer system are maintained by different parties and are in separate physical locations.

In a feature of this aspect, the GUI further comprises one or more GUI controls by which a geofence is specified by a user for a user-defined rule. In further respect to this, the one or more GUI controls may enable a user to specify the geofence by drawing on a map: the one or more GUI controls enable a user to specify the geofence by specifying a geometric shape on a map; the one or more GUI controls may enable a user to specify the geofence by specifying a route on a map; the one or more GUI controls may enable a user to specify the geofence by specifying a tripwire on a map; the one or more GUI controls may enable a user to specify the geofence by specifying a polygon on a map; and combinations thereof.

In a feature of this aspect, the GUI further comprises one or more GUI controls by which one or more records of the CRM computer system are specified by a user for which the user-defined rule applies.

In a feature of this aspect, the GUI further comprises one or more GUI controls by which a filter is specified by a user for a user-defined rule, the filter being applicable to records of the CRM computer system for identifying records to which the user-defined rule applies.

In a feature of this aspect, the GUI further comprises one or more GUI controls by which a time frame is specified by a user for a user-defined rule, the time frame identifying when the user-defined rule applies.

In a feature of this aspect, the GUI further comprises one or more GUI controls by which a time of day is specified by a user for a user-defined rule, the time of day identifying when the user-defined rule applies.

In a feature of this aspect, the GUI further comprises one or more GUI controls by which a time is specified by a user for a user-defined rule, the time identifying when the user-defined rule applies.

In a feature of this aspect, the one or more GUI controls comprise a plurality of GUI controls by which a user builds a rule, each of the plurality of GUI controls corresponding to a portion of the rule that is built.

In a feature of this aspect, the CRM computer system is configured to store accounts comprising customer data, wherein each account corresponds to a business, wherein for each account one or more of the users are associated therewith, wherein each user-defined rule is associated with the account of the user defining the rule, and wherein the account association of each user-defined rule is communicated to, and stored in non-transient computer-readable medium by, the rules-based computer system. In further respect to this feature, the customer data of each account in the CRM system may comprise client contact info, client accounts, cases, work orders, leads, and sales opportunities of the business corresponding to the account.

In a feature of this aspect, the GUI further comprises one or more GUI controls by which an asset is specified by a user for a user-defined rule relating to asset tracking. In further respect to this feature, the GUI may comprise one or more GUI controls by which an event of an asset is specified by a user as a condition for a user-defined rule related to asset tracking. For example, the asset may comprise a manually driven vehicle and the event of the asset comprises hard breaking of the vehicle by a driver; the asset may comprise a sales rep and the event of the asset comprises stopping of the sales rep for greater than a predetermined number of minutes; and the asset comprises a manually driven vehicle and the event of the asset comprises hard breaking of the vehicle by a driver.

In another aspect, a computer system comprises hardware and software that together are configured to provide both a CRM system and a geospatial rules-based system. The CRM system is accessible by users over the Internet and provides access by the users to a GUI by which the users define rules. The GUI comprises one or more windows, pages, or the like, each comprising one or more GUI controls by which each rule is defined by the user to comprise one or more conditions, and one or more associated actions to be taken upon the meeting of the one or more conditions. The CRM system and the geospatial rules-based system are configured for electronic communications with one another and the geospatial rules-based system is configured to receive over the Internet geospatial data acquired by a plurality of connected devices. The geospatial rules-based system is further configured to electronically receive from the CRM system and store rules defined by the users using the GUI; to apply the stored user-defined rules to geospatial data that is received over the Internet the geospatial data acquired by the plurality of connected devices, and to take the one or more actions of each user-defined rule upon the one or more conditions of the rule being met.

In yet another feature of this aspect, the GUI further comprises one or more GUI controls by which a location is specified by a user for a user-defined rule related to location-based automation. The location-based automation may comprise a workflow that is performed as an action of the rule to be taken; creation of an event at an appointment in the CRM system as an action of the rule to be taken; the automatic checking-in for an appointment in the CRM system as an action of the rule to be taken: the automatic checking-out for an appointment in the CRM system as an action of the rule to be taken; the automatic recording for reporting of an activity as an action of the rule to be taken; the automatic logging of mileage of a vehicle as an action of the rule to be taken; and any combination of the foregoing.

In yet another aspect, a computer-implemented method comprises: (a) providing a GUI that is accessible by users within a CRM solution, by which GUI the users define rules, the GUI comprising one or more windows, pages, or the like, each comprising one or more GUI controls by which each rule is defined by the user to comprise one or more conditions, and one or more associated actions to be taken upon the meeting of the one or more conditions; (b) receiving from a user via the GUI one or more user-defined rules, each user-defined rule comprising one or more selected conditions and one or more selected actions to be taken upon the meeting of the one or more conditions; (c) storing in non-transitory computer readable medium each received user-defined rule for later retrieval and processing: (d) electronically receiving, over the Internet, geospatial data acquired by a plurality of connected devices: (e) identifying stored user-defined rules applicable to the received geospatial data: (f) retrieving the identified stored user-defined rules; (g) applying the retrieved user-defined rules to the received geospatial data; and (h) taking the one or more actions of each retrieved user-defined rule upon the one or more conditions of the retrieved user-defined rule being met based on the received geospatial data.

In a feature of this aspect, steps (a) through (h) are performed within the CRM solution.

In a feature of this aspect, step (a) is performed within the CRM solution and steps (b) through (h) are performed outside of the CRM solution. The CRM solution may be provided by a first group of one or more web servers which perform step (a), and steps (b) through (h) may be performed by a second group of web servers. Furthermore, the first group of one or more web servers may be accessible by users over the Internet at a first set of network IP addresses, and the second group of one or more web servers may be accessible over the Internet at a second set of network IP addresses. The method further may comprise electronically communicating each user-defined rule from the CRM solution to the second group of one or more web servers for storing and processing.

In a feature of this aspect, applying the retrieved user-defined rules to the received geospatial data comprises determining if the one or more conditions are met of each of the retrieved user-defined rules.

In a feature of this aspect, the method further comprises determining that the one or more conditions of a retrieved user-defined rule are met upon a connected device entering an area represented by a geofence that is specified in the user-defined rule.

In a feature of this aspect the method further comprises determining that the one or more conditions of a retrieved user-defined rule are met upon a connected device leaving an area represented by a geofence that is specified in the user-defined rule.

In a feature of this aspect, the method further comprises determining that the one or more conditions of a retrieved user-defined rule are met upon a connected device remaining for a predetermined time within an area represented by a geofence that is specified in the user-defined rule.

In a feature of this aspect, taking the one or more actions of a retrieved user-defined rule upon determining that the one or more conditions of the user-defined rule are met comprise sending an alert regarding a noncompliance with safety regulations that is determined to have occurred by the geospatial rules-based system.

In a feature of this aspect, taking the one or more actions of a retrieved user-defined rule upon determining that the one or more conditions of the user-defined rule are met comprise sending an alert regarding a malfunction that is determined by the geospatial rules-based system to have occurred.

In a feature of this aspect, taking the one or more actions of a retrieved user-defined rule upon determining that the one or more conditions of the user-defined rule are met comprise sending an email.

In a feature of this aspect, taking the one or more actions of a retrieved user-defined rule upon determining that the one or more conditions of the user-defined rule are met comprise sending an SMS message.

In a feature of this aspect, taking the one or more actions of a retrieved user-defined rule upon determining that the one or more conditions of the user-defined rule are met comprise sending a report for a sales rep to a manager of the sales rep with activity including mileage and hours worked.

In a feature of this aspect, taking the one or more actions of a retrieved user-defined rule upon determining that the one or more conditions of the user-defined rule are met comprise providing an alert regarding vehicle starts and stops.

In a feature of this aspect, taking the one or more actions of a retrieved user-defined rule upon determining that the one or more conditions of the user-defined rule are met comprise providing an alert regarding a deviation of a traveling asset from an assigned route.

In a feature of this aspect, taking the one or more actions of a retrieved user-defined rule upon determining that the one or more conditions of the user-defined rule are met comprise providing an alert to a customer regarding a changed estimated-time-of-arrival of an asset traveling to the customer based on real-time traffic conditions and real-time location of the asset.

In a feature of this aspect, taking the one or more actions of a retrieved user-defined rule upon determining that the one or more conditions of the user-defined rule are met comprise providing an alert to a customer upon an arrival of an asset at a location of the customer.

In a feature of this aspect, taking the one or more actions of a retrieved user-defined rule upon determining that the one or more conditions of the user-defined rule are met comprise sending a communication via an organizational communication tool.

In a feature of this aspect, taking the one or more actions of a retrieved user-defined rule upon determining that the one or more conditions of the user-defined rule are met comprise sending a communication via Salesforce Chatter.

In a feature of this aspect, taking the one or more actions of a retrieved user-defined rule upon determining that the one or more conditions of the user-defined rule are met comprise adding a record to the CRM solution by the geospatial rules-based system. Adding, deleting, changing, or retrieving a record in the CRM solution may comprise sending an http communication to the CRM solution to effect the action, which http communication may be RESTful.

In a feature of this aspect, the provided GUI comprises a map-based graphical user interface.

In a feature of this aspect, the provided GUI further comprises one or more GUI controls by which an identification of a vendor of a connected device is specified for each user-defined rule.

In a feature of this aspect, the provided GUI further comprises one or more GUI controls by which an identification of a type of a connected device is specified for each user-defined rule.

In a feature of this aspect, the provided GU further comprises one or more GUI controls by which an identification of a connected device is specified for each user-defined rule.

In a feature of this aspect, the provided GUI further comprises one or more GUI controls by which a geofence is specified by a user for a user-defined rule.

The geofence may be specified by the user by drawing on a map; by specifying a geometric shape on a map; by specifying a route on a map; by specifying a tripwire on a map; or by specifying a polygon on a map.

In a feature of this aspect, the provided GUI further comprises one or more GUI controls by which one or more records of the CRM solution are specified by a user for which the user-defined rule applies.

In a feature of this aspect, the provided GUI further comprises one or more GUI controls by which a filter is specified by a user for a user-defined rule, the filter being applicable to records of the CRM solution for identifying records to which the user-defined rule applies.

In a feature of this aspect, the provided GUI further comprises one or more GUI controls by which a time frame is specified by a user for a user-defined rule, the time frame identifying when the user-defined rule applies.

In a feature of this aspect, the provided GUI further comprises one or more GUI controls by which a time of day is specified by a user for a user-defined rule, the time of day identifying when the user-defined rule applies.

In a feature of this aspect the provided GUI further comprises one or more GUI controls by which a time is specified by a user for a user-defined rule, the time identifying when the user-defined rule applies.

In a feature of this aspect, the GUI controls comprise a plurality of GUI controls by which a user builds a rule, each of the plurality of GUI controls corresponding to a portion of the rule that is built.

In a feature of this aspect, the method further comprises storing accounts comprising customer data, wherein each account corresponds to a business, wherein for each account one or more of the users are associated therewith, wherein each user-defined rule is associated with the account of the user defining the rule, and wherein the account association of each user-defined rule is stored with the user-defined rule in the non-transitory computer-readable medium. The customer data of each account in the CRM solution may comprise client contact info, client accounts, cases, work orders, leads, and sales opportunities of the business corresponding to the account.

In a feature of this aspect, the provided GUI further comprises one or more GUI controls by which an asset is specified by a user for a user-defined rule relating to asset tracking. The provided GUI may comprise one or more GUI controls by which an event of an asset is specified by a user as a condition for a user-defined rule related to asset tracking. The asset may comprise a manually driven vehicle and the event of the asset comprises hard breaking of the vehicle by a driver, the asset may comprise a sales rep and the event of the asset comprises stopping of the sales rep for greater than a predetermined number of minutes: and the asset may comprise a manually driven vehicle and the event of the asset comprises hard breaking of the vehicle by a driver.

In a feature of this aspect, the provided GUI further comprises one or more GUI controls by which a location is specified by a user for a user-defined rule related to location-based automation. The location-based automation may comprise: a workflow that is performed as an action of the rule to be taken; creation of an event at an appointment in the CRM solution as an action of the rule to be taken; the automatic checking-in for an appointment in the CRM solution as an action of the rule to be taken, the automatic checking-out for an appointment in the CRM solution as an action of the rule to be taken; the automatic recording for reporting of an activity as an action of the rule to be taken; and the automatic logging of mileage of a vehicle as an action of the rule to be taken.

In another aspect, a computerized system comprises: hardware and software together configured to provide an asset-tracking computer system for monitoring and tracking assets; and hardware and software together configured to provide a rules-based computer system for applying user-defined rules to data received from the asset-tracking computer system. The asset-tracking computer system is accessible by users at a first set of one or more network IP addresses and provides access by the users to a GUI by which the users define rules. The GUI comprises one or more windows, pages, or the like, each comprising one or more GUI controls by which each rule is defined by the user to comprise, one or more conditions, and one or more associated actions to be taken upon the meeting of the one or more conditions. The rules-based computer system is accessible at a second set of one or more network IP addresses different from the first set of network IP addresses, whereby the asset-tracking computer system and the rules-based computer system are configured for electronic communications with one another and whereby the rules-based computer system is configured to receive data acquired by a plurality of connected devices. The rules-based computer system is configured to electronically receive over the Internet from the asset-tracking computer system, and store in non-transitory computer-readable medium, rules defined by the users using the GUI; apply user-defined rules stored in the non-transitory computer-readable medium to received data acquired by the plurality of connected devices; and take the one or more actions of each user-defined rule upon the one or more conditions of the rule being met.

In a feature, the rules-based system comprises geospatial rules defined by users using the GUI, and wherein the received data comprises geospatial data.

In a feature, the rules-based system comprises event-based rules defined by users using the GUI.

In another aspect, a computer system comprises hardware and software together configured to provide an asset-tracking system, and a rules-based system. The asset-tracking system is accessible by users over the Internet and provides access by the users to a GUI by which the users define rules. The GUI comprises one or more windows, pages, or the like, each comprising one or more GUI controls by which each rule is defined by the user to comprise one or more conditions, and one or more associated actions to be taken upon the meeting of the one or more conditions. The asset-tracking system and the rules-based system are configured for electronic communications with one another and whereby the rules-based system is configured to receive over the Internet data acquired by a plurality of connected devices. The rules-based system is configured to electronically receive from the asset-tracking system and store rules defined by the users using the GUI; apply the stored user-defined rules to data that is received over the Internet the data acquired by the plurality of connected devices; and take the one or more actions of each user-defined rule upon the one or more conditions of the rule being met.

In a feature, the rules-based system comprises geospatial rules defined by users using the GUI, and wherein the received data comprises geospatial data.

In a feature, the rules-based system comprises event-based rules defined by users using the GUI.

In another aspect, a computer-implemented method, comprises: providing a GUI that is accessible by users within a computerized asset-tracking system, by which GUI the users define rules, the GUI comprising one or more windows, pages, or the like, each comprising one or more GUI controls by which each rule is defined by the user to comprise one or more conditions, and one or more associated actions to be taken upon the meeting of the one or more conditions; receiving from a user via the GUI one or more user-defined rules, each user-defined rule comprising one or more selected conditions and one or more selected actions to be taken upon the meeting of the one or more conditions: storing in non-transitory computer readable medium each received user-defined rule for later retrieval and processing: electronically receiving, over the Internet, data acquired by a plurality of connected devices; identifying stored user-defined rules applicable to the received data; retrieving the identified stored user-defined rules; applying the retrieved user-defined rules to the received data; and taking the one or more actions of each retrieved user-defined rule upon the one or more conditions of the retrieved user-defined rule being met based on the received data.

In a feature, the rules-based system comprises geospatial rules defined by users using the GUI, and wherein the received data comprises geospatial data.

In a feature, the rules-based system comprises event-based rules defined by users using the GUI.

In another aspect, a computer-readable medium contains computer-executable instructions for performing a method in accordance with any of the foregoing aspect and features.

In addition to the aforementioned aspects and features of the present invention, it should be noted that the present invention further encompasses the various logical combinations and subcombinations of such aspects and features. Thus, for example, claims in this or a divisional or continuing patent application or applications may be separately directed to any aspect, feature, or embodiment disclosed herein, or combination thereof, without requiring any other aspect, feature, or embodiment.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a schematic illustration of a preferred system in accordance with one or more preferred embodiments of the invention and FIG. 1A illustrates a preferred architecture thereof.

FIG. 2 is a schematic illustration of an interface of a CRM application in accordance with one or more preferred embodiments of the invention.

FIG. 3 is a schematic illustration of an initial window of a preferred GUI within a CRM application, by which GUI users define rules in accordance with one or more preferred embodiments of the invention.

FIG. 4 is a schematic illustration of a subsequent view of the window of FIG. 3 in accordance with one or more preferred embodiments of the invention.

FIG. 5 is a schematic illustration of steps of a preferred computer-implemented method in accordance with one or more preferred embodiments of the invention.

FIG. 6 illustrates a web browser in which a GUI is displayed to a user comprising a Rules Dashboard.

FIG. 7 illustrates a new rule creation interface configured to allow a user to define a new rule.

FIG. 8 illustrates a details pane of a new rule creation interface which allows a user to specify a name and description for a new rule.

FIGS. 9-11 illustrate a devices pane of a new rule creation interface which allows a user to specify a device layer to apply a new rule to.

FIGS. 12-13 illustrate a conditions pane of a new rule creation interface which allows a user to specify condition logic for a new rule.

FIG. 14 illustrates an actions pane of a new rule creation interface.

FIG. 15 illustrates use of a dropdown user interface input element to select whether to filter displayed rules to only display active rules, inactive rules, rules with errors, or to display all rules.

FIG. 16 illustrates a user interface element providing access to edit, clone, and delete functionality.

FIG. 17 illustrates a web browser in which a dashboard is illustrated that relates to driver safety, including speeding.

FIG. 18 illustrates a web browser in which a dashboard is illustrated that relates to driver distances and maximums speeds.

FIG. 19 illustrates a web browser in which a dashboard is illustrated that relates to efficiency.

FIG. 20 illustrates exemplary technology for implementing systems and methods in accordance with one or more preferred implementations.

### DETAILED DESCRIPTION

As a preliminary matter, it will readily be understood by one having ordinary skill in the relevant art (“Ordinary Artisan”) that the invention has broad utility and application. Furthermore, any embodiment discussed and identified as being “preferred” is considered to be part of a best mode contemplated for carrying out the invention. Other embodiments also may be discussed for additional illustrative purposes in providing a full and enabling disclosure of the invention. Furthermore, an embodiment of the invention may incorporate only one or a plurality of the aspects of the invention disclosed herein; only one or a plurality of the features disclosed herein: or combination thereof. As such, many embodiments are implicitly disclosed herein and fall within the scope of what is regarded as the invention.

Accordingly, while the invention is described herein in detail in relation to one or more embodiments, it is to be understood that this disclosure is illustrative and exemplary of the invention, and is made merely for the purposes of providing a full and enabling disclosure of the invention. The detailed disclosure herein of one or more embodiments is not intended, nor is to be construed, to limit the scope of patent protection afforded the invention in any claim of a patent issuing here from, which scope is to be defined by the claims and the equivalents thereof. It is not intended that the scope of patent protection afforded the invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the invention. Accordingly, it is intended that the scope of patent protection afforded the invention is to be defined by the issued claim(s) rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

With regard solely to construction of any claim with respect to the United States, no claim element is to be interpreted under 35 U.S.C. 112(f) unless the explicit phrase “means for” or “step for” is actually used in such claim element, whereupon this statutory provision is intended to and should apply in the interpretation of such claim element. With regard to any method claim including a condition precedent step, such method requires the condition precedent to be met and the step to be performed at least once during performance of the claimed method.

Furthermore, it is important to note that, as used herein, “a” and “an” each generally denotes “at least one”, but does not exclude a plurality unless the contextual use dictates otherwise. Thus, reference to “a picnic basket having an apple” describes “a picnic basket having at least one apple” as well as “a picnic basket having apples”. In contrast, reference to “a picnic basket having a single apple” describes “a picnic basket having only one apple”.

When used herein to join a list of items, “or” denotes “at least one of the items”, but does not exclude a plurality of items of the list. Thus, reference to “a picnic basket having cheese or crackers” describes “a picnic basket having cheese without crackers”. “a picnic basket having crackers without cheese”, and “a picnic basket having both cheese and crackers”. When used herein to join a list of items, “and” denotes “all of the items of the list”. Thus, reference to “a picnic basket having cheese and crackers” describes “a picnic basket having cheese, wherein the picnic basket further has crackers”, as well as describes “a picnic basket having crackers, wherein the picnic basket further has cheese”.

Additionally, “IoT” and “Internet of Things” where used herein is intended to refer to the internetworking of physical objects, each having hardware and software configured to collect and electronically communicate data over the Internet. Such objects may be referred to herein as “connected devices” and “smart devices”. Examples of such objects include by way of example, and not limitation, vehicles, international shipping containers, mobile phones, watches, computer tablets, and laptops. And as used herein, a “geofence” means a virtual boundary of a physical area, wherein a connected device that crosses the geofence-including entering the area, exiting the area, or both-triggers an action, such as the sending of a text message or email. A connected device may be determined to have crossed a geofence based on global positioning computer system (GPS) data, radio frequency identification (RFID) data, or both.

Referring now to the drawings, one or more preferred embodiments of the invention are next described. The following description of one or more preferred embodiments is merely exemplary in nature and is in no way intended to limit the invention, its implementations, or uses.

Furthermore, U.S. Patent Appl. Publ. No. 2009/0322510, which is hereby incorporated herein by reference, discloses the securing, monitoring, and tracking of shipping containers and, in particular, international shipping containers such as the 20-foot and 40-foot ISO-standard containers. In this regard, a wireless communication device is attached to each container and is configured to electronically communicate over a network with a server, which network may comprise the Internet, cellular network, Satellite network, and combinations thereof. This U.S. patent application publication further incorporates other U.S. patent application publications and patents, each of which is incorporated herein by reference. The incorporated disclosures of these U.S. patent application publications and patents is exemplary of technologies that may be utilized in implementing preferred embodiments of methods and computer systems of the present invention.

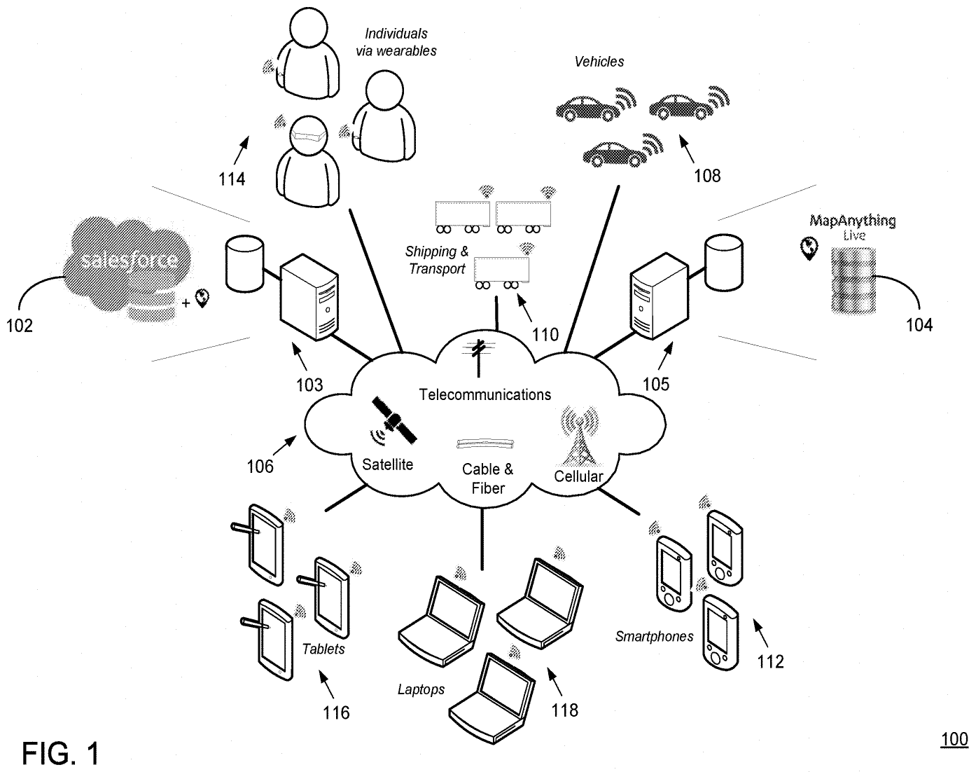

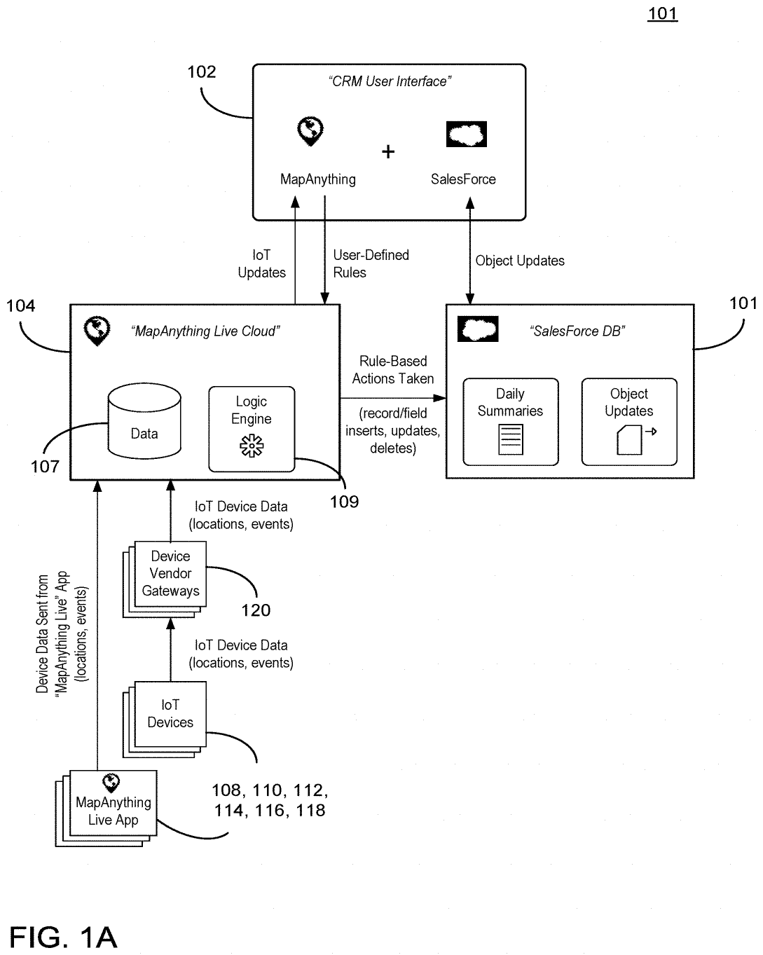

A preferred system 100 is illustrated in FIG. 1, and a preferred architecture 101 for the preferred system 100 is illustrated in FIG. 1A.

The system 100 comprises hardware and software, which is indicated generally at 103, and which hardware and software together are configured to provide a CRM computer system 102. The CRM computer system 102 preferably comprises a plurality of web servers and databases with geographic redundancy. The CRM computer system in a preferred commercial implementation is provided by Salesforce.com Inc. and includes third-party apps integrated therewith, including the “MapAnything” apps from MapAnything, Inc.

The system 100 additionally comprises hardware and software, which is indicated generally at 105, and which hardware and software together are configured to provide a geospatial rules-based computer system 104. The geospatial rules-based system 104 preferably comprises a plurality of web servers and databases with geographic redundancy. The geospatial rules-based system 104 is described in detail below. Furthermore, geospatial rules-based system 104 in the same preferred commercial implementation is provided by MapAnything, Inc. under the “MapAnything Live” offering.

The CRM computer system 102 and the geospatial rules-based computer system 104 in at least one or more preferred embodiments are maintained by different parties at separate physical or virtual locations. Furthermore, the CRM computer system 102 is accessible at a first set of one or more network IP addresses—or equivalently one or more URLs. Similarly, the geospatial rules-based computer system 104 is accessible at a second set of one or more network IP addresses—or equivalently one or more URLs, which are different from the first set of network IP addresses. Preferably, each computer system 102,104 thereby is enabled for electronic communications over a wide area computer network (WAN) or global computer network, which is indicated generally in FIG. 1 by cloud 106. The cloud 106 preferably comprises the Internet. As such, the CRM computer system 102 and the geospatial rules-based computer system 104 are configured for electronic communications with one another over the cloud 106 using one or more of the first set of network IP addresses and the second set of network IP addresses. Preferably the electronic communications between the two computer systems 102,104 are secured by encryption and may utilize one or more other technological and communication protocol safeguards.

The electronic communications between the two computer systems 102,104 preferably include the communication of rules from the CRM computer system 102 to the geospatial rules-based computer system 104, which rules are received and stored in non-transitory computer-readable medium by the geospatial rules-based computer system 104, and preferably in a database of the geospatial rules-based computer system 104. The rules and creation thereof at the CRM computer system 102 is described in detail below.

The cloud 106 preferably represents an open and publicly accessible communications infrastructure such as the Internet. As such, the CRM computer system 102 preferably is accessible over the cloud 106 for authorized communications using one or more of the first set of network IP addresses. Similarly, the geospatial rules-based computer system 104 preferably is accessible over the cloud 106 for authorized communications using one or more of the second set of network IP addresses.

The CRM computer system 102—through a CRM application—enables users of the CRM computer system 102 having networked devices to store and manage prospect and customer information, like contact info, accounts, cases, work orders, leads, and sales opportunities, in a single online platform, i.e., in “the cloud”. The CRM solution is scalable and provides access to a user when needed, wherever located, so long as the networked device has network connectivity.

The geospatial rules-based computer system 104 is configured to receive data and—preferably event data including geospatial data-acquired by a plurality of connected devices in the context of the “Internet of Things”. With reference to FIG. 1, such connected devices include by way of example and not limitation: vehicles indicated generally at 108: shipping & transport vehicles and containers having telematic devices, indicated generally at 110; mobile phones, indicated generally at 112; individuals having wearables, including smartwatches like Apple watches, health devices like Fitbits, and eyewear like Google glass, all indicated generally at 114; computer tablets, indicated generally at 116; and laptops, indicated generally at 118. It will further be appreciated that connected device of course could—and preferably do—comprise Android and iOS devices, and that the networked devices by which users access and make use of the CRM computer system 102 may comprise desktop computers as well as such connected devices, including laptops, tablets, and smartphones that are carried by users in the field.

Specifically, connected devices are configured to communicate geospatial data to the geospatial rules-based computer system 104 over the cloud 106 using the one or more of the second set of network IP addresses. The geospatial data communicated to the geospatial rules-based computer system 104 from a connected device may comprise the coordinates for the connected device itself or coordinates from another connected device that has been communicated to such connected device. Moreover, the coordinates preferably are GPS coordinates obtained from a GPS system or coordinates provided by an RFID asset-tracking system. Such geospatial data further may include a timestamp representing the date and time the relevant connected device was located at the coordinates. Connected devices preferably communicate the geospatial data on demand upon receiving a request, at routine intervals of time, upon a detected location change, when such data is received, and any combination thereof. Pathways for communicating such geospatial data may comprise satellite communications, cellular communications, communications over telephone networks, and communications over fiber and cable networks, ultimately reaching geospatial rules-based computer system 104 at one or more of the network IP addresses of such computer system, as graphically indicated within the cloud 106 in FIG. 1.

Communication of the geospatial data may be received directly from the connected devices, wherein the end points of the communications are connected devices on the one hand, and the geospatial rules-based computer system on the other hand. Within this context, the connected devices preferably include software specifically configured to communicate and work with the geospatial rules-based computer system. Is also contemplated that the geospatial data may be collected and aggregated and, thereafter, collectively communicated to the geospatial rules-based computer system. Such collection and aggregation for later communication to the geospatial rules-based computer system may be done, for example, by one or more gateways 120 of an Internet service provider, a cellular provider, a cable provider, or a satellite communications provider, or a connected device provider or vendor. Furthermore, such communication from a provider may be done upon receiving a request, at routine intervals of time, upon a detected location change of a connected device, and any combination thereof. Pathways for such communication also may comprise satellite communications, cellular communications, communications over telephone networks, and communications over fiber and cable networks, ultimately reaching geospatial rules-based computer system 104 at one or more of the network IP addresses of such computer system, as graphically indicated within the cloud 106 in FIG. 1. Thus, the geospatial rules-based computer system may be configured to electronically communicate with and receive the collected and aggregated data over the Internet from one or more gateways of one or more third party providers.

In view of the foregoing, it will be understood that the geospatial rules-based computer system 104 preferably is configured to electronically receive over the Internet geospatial data that is acquired by a plurality of connected devices, whether by direct or indirect communications with the connected devices.

Additionally, the geospatial rules-based computer system 104 preferably is configured to apply to the received geospatial data rules that are stored in the non-transitory computer-readable medium at the geospatial rules-based computer system 104; and to take one or more actions in accordance with a rule when a condition or conditions of a rule are met.

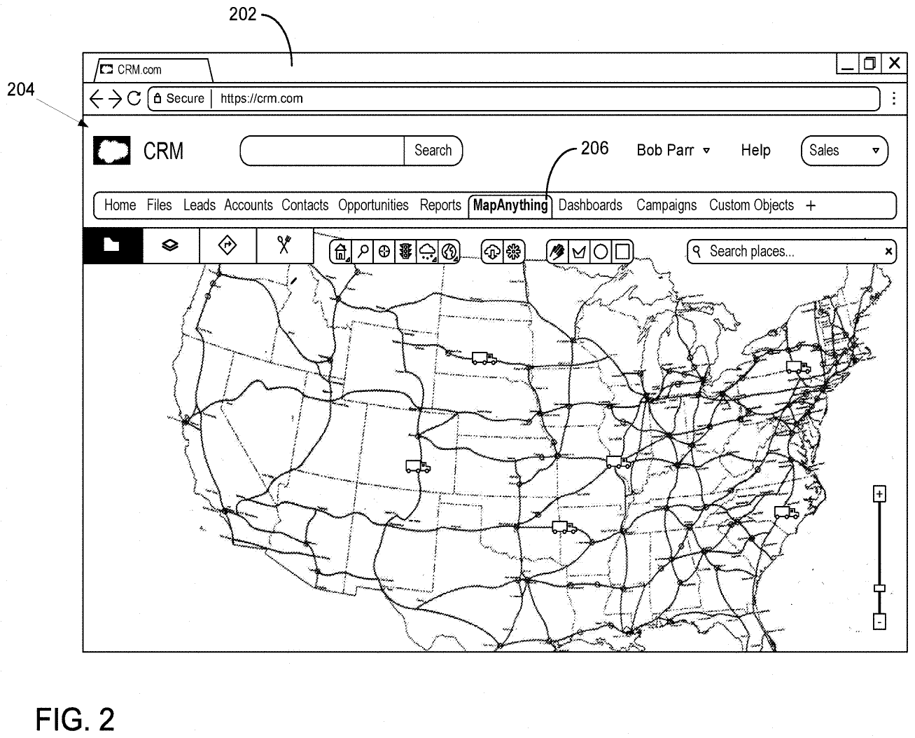

The rules received by the geospatial rules-based computer system 104 from the CRM computer system 102 are defined by the users of the CRM computer system 102. The rule is defined by a user by way of a GUI specifically engineered for creating user-defined rules. The GUI is implemented within the context of the CRM interface by which users make use of the CRM computer system 102. Indeed, it is contemplated that the GUI is part of a geo-analytical program representing an optional add-on or additional module for integration with and use within a CRM application. An example of such integration is illustrated in FIG. 2, wherein a tab control includes tabbed pages—generally indicated at 204—that are provided as part of a primary interface 202 for a CRM application provided by Salesforce.com Inc. A geo-analytical program is seamlessly integrated into the CRM application through the addition of a tabbed page 206 which has been selected and is in focus in FIG. 2. The tabbed page 206 seen here is generated by an add-on program provided by MapAnything Inc.; bears the tabbed page title “MapAnything”; and is available for example through the Salesforce AppExchange marketplace. More specifically, data 107 and logic engine 109 for the geo-analytical program preferably is located at the geospatial rules-based computer system, while the GUI for creating user-defined rules is integrated into the CRM application and represents the means by which users interact with and define rules that are applied in the geospatial rules-based computer system.

In one embodiment, the GUI is implemented through a series of windows, pages, or the like that are launched by selection of a button or another element in the tabbed page 206. Each window, page, or the like of the GUI comprises one or more GUI controls by which each rule is defined by the user. Each rule as selected by the user comprises one or more conditions, and one or more associated actions to be taken upon the meeting of the one or more conditions. As such, the GUI controls provide an interface by which a user specifies one or more conditions for a rule. Moreover, the conditions may be conjunctive (i.e., each condition of one or more specified conditions needing to be met in order to cause performance of the one or more actions of the rule) or may be in the disjunctive (i.e., only one condition of a plurality of specified conditions having to be met in order to cause performance of the one or more actions of the rule).

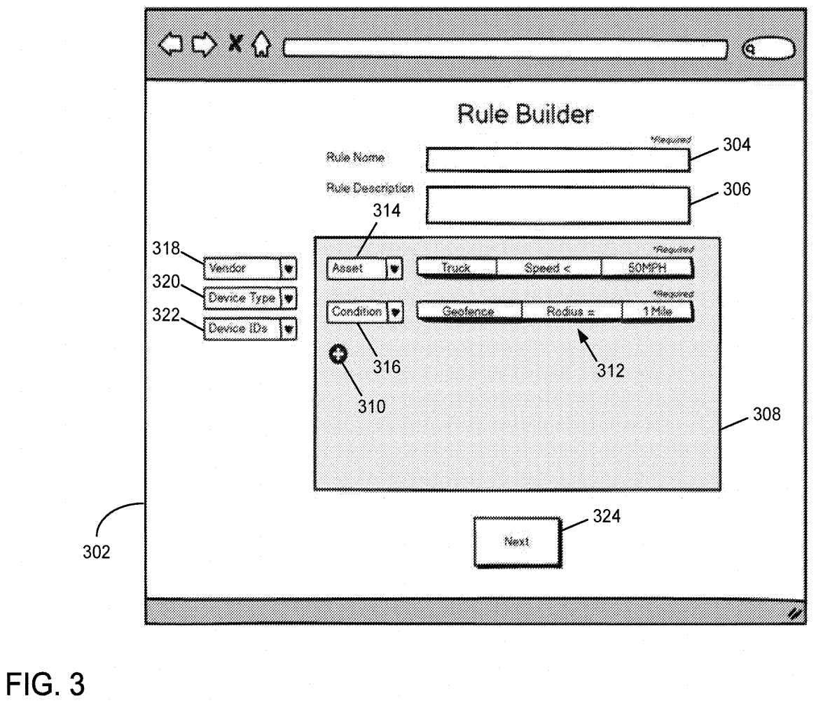

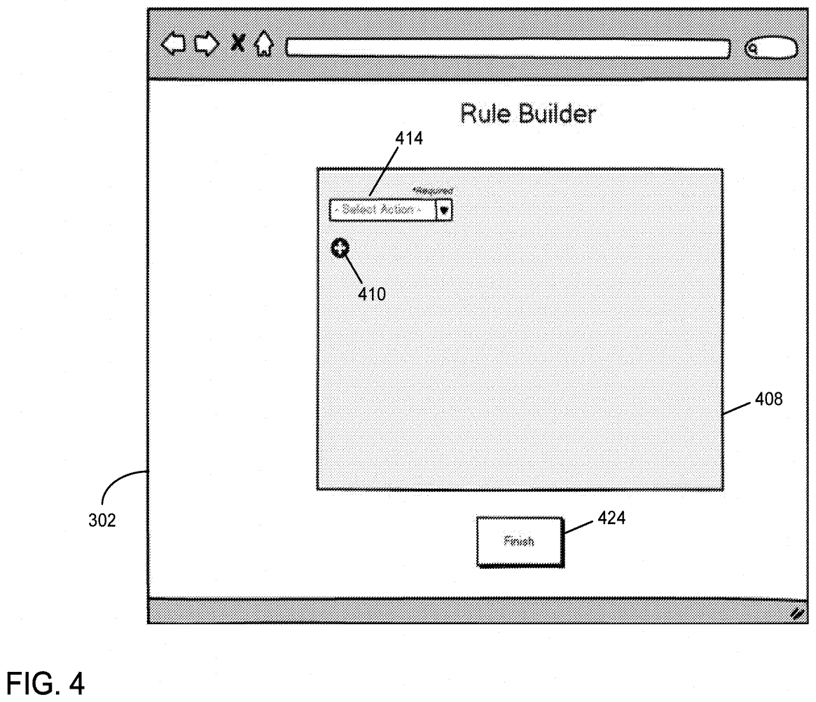

An example of a first window 302 of the GUI for defining or “building” a rule by a user is shown schematically in FIG. 3. The window 302 is seen to be a web browser window including a navigation pane at the top and the window 302 is for illustration of a preferred embodiment and is not a limitation. The window 302 comprises a number of GUI controls including a first text box 304 by which the user provides a name for the rule being created, which is deemed to be required, and a second text box 306 by which the user provides a description of the rule being created. The window 302 also comprises a container 308 having GUI controls for specifying one or more assets and one or more conditions. Each asset and each condition is specified on a line-by-line basis, with the ability to add additional lines by selecting button 310 for additional assets and conditions to be specified, if desired.

At least one asset and at least one condition are specified for a rule, as seen in FIG. 2 by the “Required” label positioned by each of the first two lines. The first line-specifying an asset in FIG. 2—identifies a “Truck” with a parameter of “Speed” and operating of “Less Than” and value of “50 MPH”. The second line-specifying a condition in FIG. 3 and generally indicated at 312—identifies a “Geofence” having a “Radius” with operator “Equal” and value “1 Mile”. Whether an asset or a condition is specified by a particular line is selected by a user by way of, for example, dropdown list controls 314,316 each having “Asset” and “Condition” as the choices. Actuating button 310 by selecting it creates a new line beginning with this dropdown list control, whereby the user specifies whether the line being built is for an asset or a condition. As such, a user builds a rule using the GUI controls, each GUI control corresponding to a portion of the rule being built.

In addition to specifying one or more conditions by the user and one or more assets in window 302, controls 318,320,322 are also provided for specifying a vendor, device type, and device IDs.

Examples of conditions that may be specified by users in a rules include: a connected device entering an area represented by a geofence that is specified in a user-defined rule; a connected device leaving an area represented by a geofence that is specified in a user-defined rule; a connected device remaining for a predetermined time within a bounded area (shape geofence); a connected device crossing a geographical boundary (linear geofence): and any combination thereof.

Other exemplary conditions include: a vehicle ignition being on or being off: a vehicle moving or stopped; a vehicular speed exceeding a threshold or exceeding an applicable speed limit as determined based on vehicular position; a vehicular acceleration exceeding a threshold; a vehicular deceleration exceeding a threshold; a vehicular seat belt not being engaged during vehicular motion above a threshold: an odometer value exceeding a threshold or a change in odometer value exceeding a threshold over a given time period: an engine issue being detected by a sensor, a reported fuel economy falling short of a minimum threshold; a time period of engine idle exceeding a threshold; and availability of an asset in the field to perform a task, such as an availability for a service call or availability for a customer sales call. With further respect to availability, this may be indicated by “pushing” a button on a connected device by a delivery person or salesperson, for instance, wherein the connected device runs a “MapAnything” app.

When at least one asset and one condition have been specified in window 302, a user may select button 324 with label “Next” for advancing to a subsequent page, which is illustrated in FIG. 3. Alternatively, a subsequent window may be shown, especially if a web browser window is not utilized. Other controls further may be used with the same or similar user experience, as will be obvious to an Ordinary Artisan, each thereof being within the scope of the current disclosure. With reference to FIG. 3, it will be seen that the subsequent page also comprises a number of GUI controls including a container 408 having GUI controls for specifying one or more actions to be taken upon the user-specified conditions having been met for the specified asset. Each action to be taken is specified on a line-by-line basis, too, with the ability to add additional lines by selecting button 410, if desired. It further will be appreciated from the “Required” label seen in the first line that at least one action is deemed to be required for a user-defined rule. Such action can be selected by a user by way of the dropdown list control 414. Additionally, it should be noted that in preferred embodiments the geospatial rules-based computer system 104 is configured to be able to perform whatever action is specified in a rule.

Examples of actions that may be specified and, thus, taken by the geospatial rules-based computer system 104 when the condition or conditions of a rule are met for an asset or assets include: sending an alert regarding a noncompliance with safety regulations that is determined by the geospatial rules-based computer system to have occurred; sending an alert regarding a malfunction that is determined by the geospatial rules-based computer system to have occurred; sending an email; sending an SMS message; sending a report for a sales rep to a manager of the sales rep with activity including mileage and hours worked: providing an alert regarding vehicle starts and stops; providing an alert regarding a deviation of a traveling asset from an assigned route; providing an alert to a customer regarding a changed estimated-time-of-arrival of an asset traveling to the customer based on real-time traffic conditions and real-time location of the asset; providing an alert to a customer upon an arrival of an asset at a location of the customer: sending a communication via an organizational communication tool: posting a chatter communication; sending a communication via Salesforce Chatter.

Other actions that may be specified in a rule are performed by the geospatial rules-based computer system 104 sending a communication to the CRM computer system 102 for adding, deleting, updating, or retrieving data of a record, or of a field of a record, in the CRM computer system 102, including, for example, records that are maintained in the CRM computer system 102. Thus, for example, an action that may be specified in a rule and that is performed by the geospatial rules-based computer system 104 may include: adding a record to the CRM computer system 102 by the geospatial rules-based computer system 104 by sending a RESTful http communication to the CRM computer system 102 to effect the addition of the record to the CRM computer system 102; changing a record in the CRM computer system 102 by the geospatial rules-based computer system 104 by sending a RESTful http communication to the CRM computer system 102 to effect the change in the record in the CRM computer system 102; deleting a record from the CRM computer system 102 by the geospatial rules-based computer system 104 by sending a RESTful http communication to the CRM computer system 102 to effect the deletion of the record from the CRM computer system 102; and retrieving a record from the CRM computer system 102 by the geospatial rules-based computer system 104 by sending a RESTful http communication to the CRM computer system 102 to effect the retrieval of the record from the CRM computer system 102. These interactions preferably are accomplished via an API of the CRM computer system 102 that is made available to the geospatial rules-based computer system 104.

In at least one or more preferred embodiments, the GUI further comprises one or more GUI controls by which one or more records of the CRM computer system are specified by a user for which the user-defined rule will be applied; the GUI further comprises one or more GUI controls by which a filter is specified by a user for a user-defined rule, the filter being applicable to records of the CRM computer system for identifying records for which the user-defined rule will be applied; the GUI further comprises one or more GUI controls by which a time frame is specified by a user for a user-defined rule, the time frame identifying when the user-defined rule will be applied; the GUI further comprises one or more GUI controls by which a time of day is specified by a user for a user-defined rule, the time of day identifying when the user-defined rule will be applied; the GUI further comprises one or more GUI controls by which a time is specified by a user for a user-defined rule, the time identifying when the user-defined rule will be applied: and any combination thereof.

Another GUI of one or more preferred embodiments comprises a map-based GUI. Such map-based GUI may comprise one or more GUI controls by which a geofence is specified by a user for a user-defined rule; one or more GUI controls that enable a user to specify a geofence by drawing on a map; one or more GUI controls that enable a user to specify a geofence by specifying a geometric shape on a map; one or more GUI controls that enable a user to specify a geofence by specifying a route on a map; one or more GUI controls that enable a user to specify a geofence by specifying a tripwire on a map; and one or more GUI controls that enable a user to specify a geofence by specifying a polygon on a map.

When at least one action has been specified by a user, button 424 with label “Finish” is selectable by the user and, upon selection thereof, the user-defined rule is communicated by the CRM computer system 102 over the cloud 106 to the geospatial rules-based computer system 104 for storing and processing. In view of the foregoing, it will be appreciated that the geospatial rules-based computer system is configured to process incoming geospatial data of the connected devices against one or more stored user-defined rules to determine if the one or more conditions are met of each of the one or more user-defined rules.

In addition to the foregoing, in at least one preferred embodiment of the invention the GUI comprises one or more GUI controls by which an asset is specified by a user, which rule is related to asset-tracking. The location-based automation may comprise, for example and not by way of limitation: a workflow that is performed as an action of the rule to be taken, creation of an event at an appointment in the CRM computer system as an action of the rule to be taken; the automatic checking-in for an appointment in the CRM system as an action of the rule to be taken; the automatic checking-out for an appointment in the CRM system as an action of the rule to be taken: the automatic recording for reporting of an activity as an action of the rule to be taken: the automatic logging of mileage of a vehicle as an action of the rule to be taken; and any combination thereof. By way of example and not limitation, the asset may comprise a manually driven vehicle and the event of the asset may comprise hard breaking of the vehicle by a driver, the asset comprises a sales rep and the event of the asset comprises stopping of the sales rep for greater than a predetermined number of minutes; or the asset may comprise a manually driven vehicle and the event of the asset comprises hard breaking of the vehicle by a driver. Furthermore, in at least one preferred embodiment, the GUI comprises one or more GUI controls by which an event of an asset is specified by a user as a condition for a user-defined rule related to asset tracking.

Additionally, in at least one preferred embodiment of the invention, the GUI comprises one or more GUI controls by which a location is specified by a user for a user-defined rule, which rule is related to location-based automation. The location-based automation may comprise, for example and not by way of limitation: a workflow that is performed as an action of the rule to be taken; creation of an event at an appointment in the CRM computer system as an action of the rule to be taken; the automatic checking-in for an appointment in the CRM system as an action of the rule to be taken; the automatic checking-out for an appointment in the CRM system as an action of the rule to be taken; the automatic recording for reporting of an activity as an action of the rule to be taken; the automatic logging of mileage of a vehicle as an action of the rule to be taken; and any combination thereof.

From the foregoing it will also be appreciated that while the GUI has been described with reference to web browser window 302, it will be understood that an explicitly contemplated alternative thereto comprises a wizard GUI, by which the same information is solicited from a user in defining a rule. Such wizard further may contain helpful hints and explanations, facilitating desired rule creation by a user.

While the foregoing description has not explicitly included a discussion of accounts in the CRM computer system 102, it will be understood and appreciated that the CRM computer system 102 is configured to store accounts comprising customer data, wherein each account corresponds to a business, wherein for each account one or more of the users are associated therewith, wherein each user-defined rule is associated with the account of the user defining the rule, and wherein the account association of each user-defined rule is communicated to, and stored in non-transient computer-readable medium by, the geospatial rules-based computer system 104. Moreover, the customer data of each account in the CRM computer system 102 preferably comprises client contact info, client accounts, cases, work orders, leads, and sales opportunities of the business corresponding to the account.

Further in this regard, at least in one or more preferred commercial embodiments, the GUI that is generated by the add-on program is developed and maintained by a first party that is the provider of the geospatial rules-based computer system. In contrast, the CRM application is developed and is maintained by another party unaffiliated with the first party, which other party is the provider of the CRM computer system. In a preferred commercial implementation, the first party is MapAnything Inc. and the other party is Salesforce.com Inc. With further reference to such preferred commercial implementation, the users preferably are customers of Salesforce.com Inc., and more specifically, employees of businesses that are the customers of Salesforce.com Inc. The customers subscribe to use the CRM solution provided by Salesforce.com Inc., and also preferably subscribe under a separate subscription to use the geospatial rules-based computer system provided by MapAnything Inc. Alternatively, the provider of the CRM solution may be a customer of the provider of the geospatial rules-based computer system. In still yet another alternative, there is a single provider of both systems.

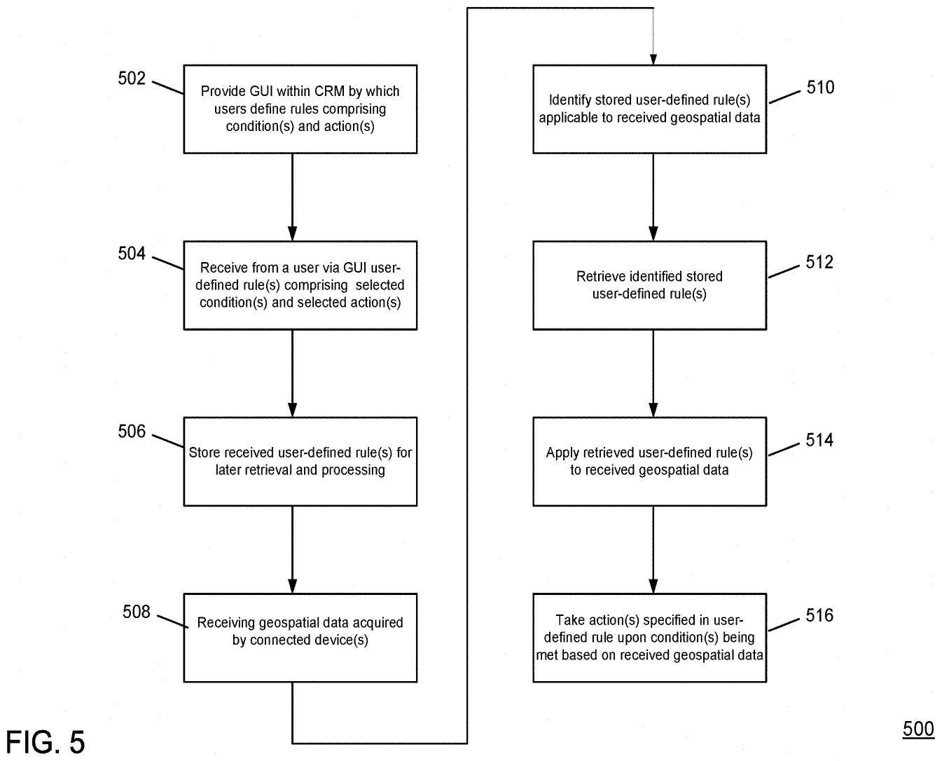

An aspect of the invention relates to a computer-implemented method which is utilized in one or more embodiments of the invention and, for example, in the systems described above. With reference to FIG. 5, a preferred such method 500 comprises providing at step 502 a GUI that is accessible by users within a CRM solution, by which GUI the users define rules, the GUI comprising one or more windows, pages, or the like, each comprising one or more GUI controls by which each rule is defined by the user to comprise one or more conditions, and one or more associated actions to be taken upon the meeting of the one or more conditions; receiving at step 504 from a user via the GUI one or more user-defined rules, each user-defined rule comprising one or more selected conditions and one or more selected actions to be taken upon the meeting of the one or more conditions; storing at step 506 in non-transitory computer readable medium each received user-defined rule for later retrieval and processing; electronically receiving at step 508, over the Internet, geospatial data acquired by a plurality of connected devices: identifying at step 510 stored user-defined rules applicable to the received geospatial data; retrieving at step 512 the identified stored user-defined rules: applying at step 514 the retrieved user-defined rules to the received geospatial data; and taking at step 516 the one or more actions of each retrieved user-defined rule upon the one or more conditions of the retrieved user-defined rule being met based on the received geospatial data.

While steps 502 through 516 may be performed in a CRM computer system, step 502 is performed within the CRM solution represented in FIG. 1, and steps 504 through 516 are performed in the geospatial rules-based computer system, which is separate from such CRM solution. For instance, the CRM solution may be provided by a first group of one or more web servers which also perform step 502, and steps 504 through 516 may be performed by a second group of web servers that are part of the geospatial rules-based computer system.

Such system processes actions and events setup by users, as well as manage communications and alerts. In addition to performing actions as specified in the user-based rules when the specified conditions are met, the geospatial data preferably is utilized in other ways. For example, users of the CRM computer system preferably have access to the data through the CRM computer system and, in particular, through an add-on program that integrates with or sits on top of the CRM application providing. Such access preferably is for analysis of the geospatial data and reports based at least in part thereon. It is further contemplated that access to the geospatial data may be obtained directly using one or more programs that operate outside of a CRM computer system.

It will be appreciated that an advantage of one or more preferred embodiments of the invention is an increase in business productivity, as well as safety and compliance, through the creation of business rules and process automation through map layers. Furthermore, it will be appreciated that using one or more preferred embodiments of the invention, users can dispatch; create location based workflows; automate mileage logs and employee time tracking: leverage workflow rules to automatically update CRM records; and track business critical data, such as fuel consumption, onsite time, and drive time hours. Indeed, one or more preferred embodiments provide business process automation using real-time vehicle telematics or tracking app data in combination with CRM records and business rules (e.g., Salesforce records and business rules), and enable real-time awareness of vehicle and human assets in conjunction with relevant CRM data such as accounts, cases and work orders.

### Preferred Commercial Implementation of GUI for User-Defined Rules

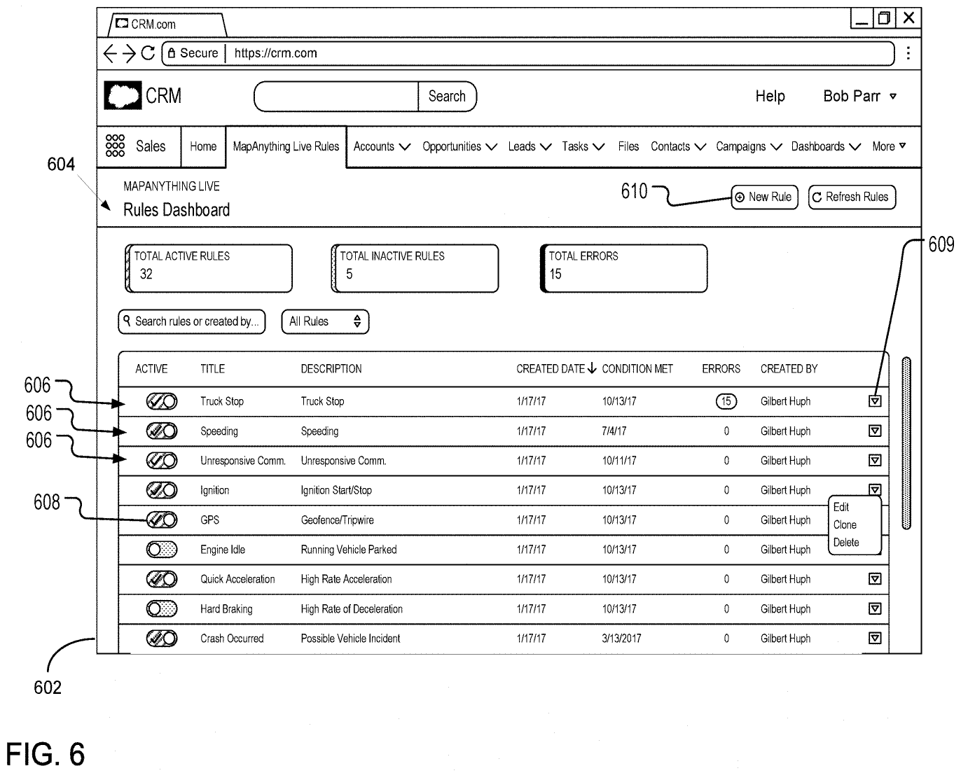

A preferred commercial implementation of a GUI for creating user-defined rules in accordance with one or more aspects and features of the invention now will be described with reference to FIGS. 6-15, which illustrate an exemplary GUI sequence for defining rules by users, which user-defined rules are applied to data sent from connected devices. The user-defined rules are stored and applied with the “MapAnything Live Cloud” offering by MapAnything. Inc., which also serves as the events manager. This offering processes actions and events setup by users via the user-defines rules, and manages communications and alerts. Users access and take advantage of the benefits of the MapAnything Live Cloud through Salesforce using the MapAnything for Salesforce offering for Salesforce.

In accordance therewith, for example, a user can define a rule to create an event in a CRM solution, such as Salesforce, based on received geospatial data sent from a connected device. A sales representative, such as a pharmaceutical sales rep, can define a rule to automatically create an event in Salesforce when the sales rep visits an account, thereby alleviating the need for the sales rep to manually log the visit in Salesforce.

In another example, a manager of an HVAC company can define: a rule that results in notification being provided to the manager when a truck/technician arrives at an appointment based on a geofence established by the rule; a rule that results in notification being provided to the manager regarding the amount of time spent at an appointment by the truck/technician based on a geofence established by the rule; and a rule that results in notification being provided to the manager when a truck/technician deviates from an assigned route.

It will be appreciated that many different rules can be created by users depending on the desires and needs of the users.

With reference to FIG. 6, a web browser 602 is illustrated in which a GUI is displayed to a user comprising a Rules Dashboard 604. The Rules Dashboard 604 provides an overview of a total number of active rules, a total number of inactive rules, and a total number of errors.

The Rules Dashboard 604 includes a plurality of rows 606 each corresponding to a listing for a rule, and allows a user to filter the displayed rules, or search existing rules. Each row includes a title of the corresponding rule, a description of the corresponding rule, a creation date for the corresponding rule, a date that a condition of the corresponding rule was met, a number of errors associated with the corresponding rule, and an indication of a user that created the corresponding rule.

Each row also includes a toggle interface element 608 which both indicates whether the corresponding rule is active or inactive, and allows a user to toggle the rule from one state to another.

Each row preferably further includes a user interface element 609 which allows a user to edit, clone, or delete the corresponding rule.

The Rules Dashboard 604 preferably further includes a “New Rule” user interface element 610 which allows a user to create a new rule by accessing a GUI comprising a new rule creation interface.

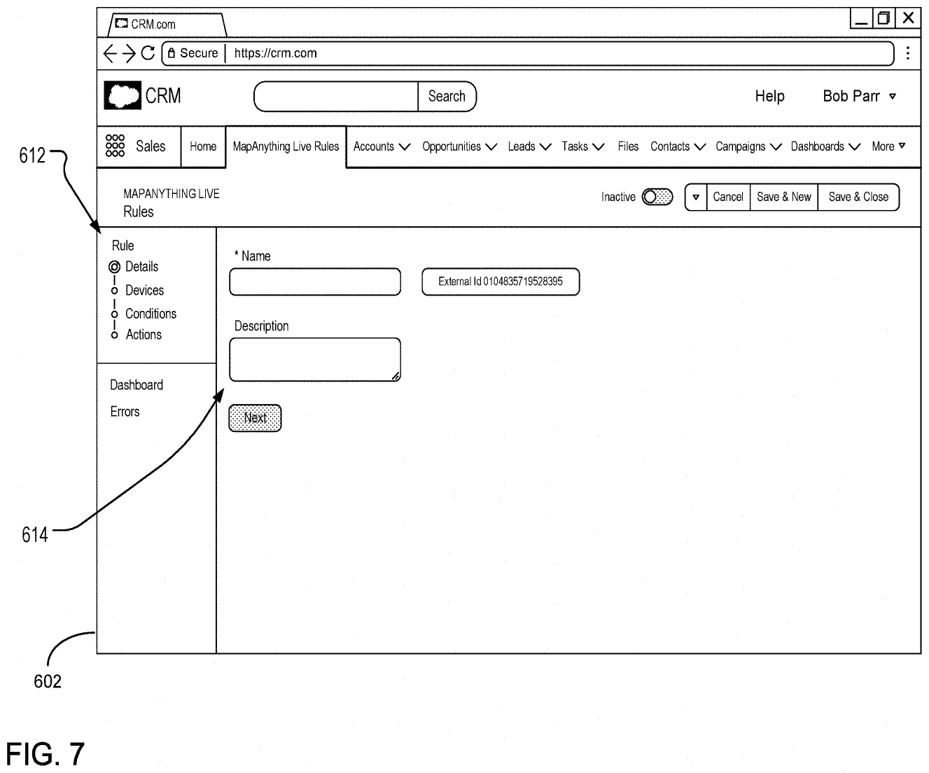

FIG. 7 illustrates a new rule creation interface 612 configured to allow a user to define a new rule. The new rule creation interface is configured to step through a number of display panes which collectively allow a user to define a new rule.

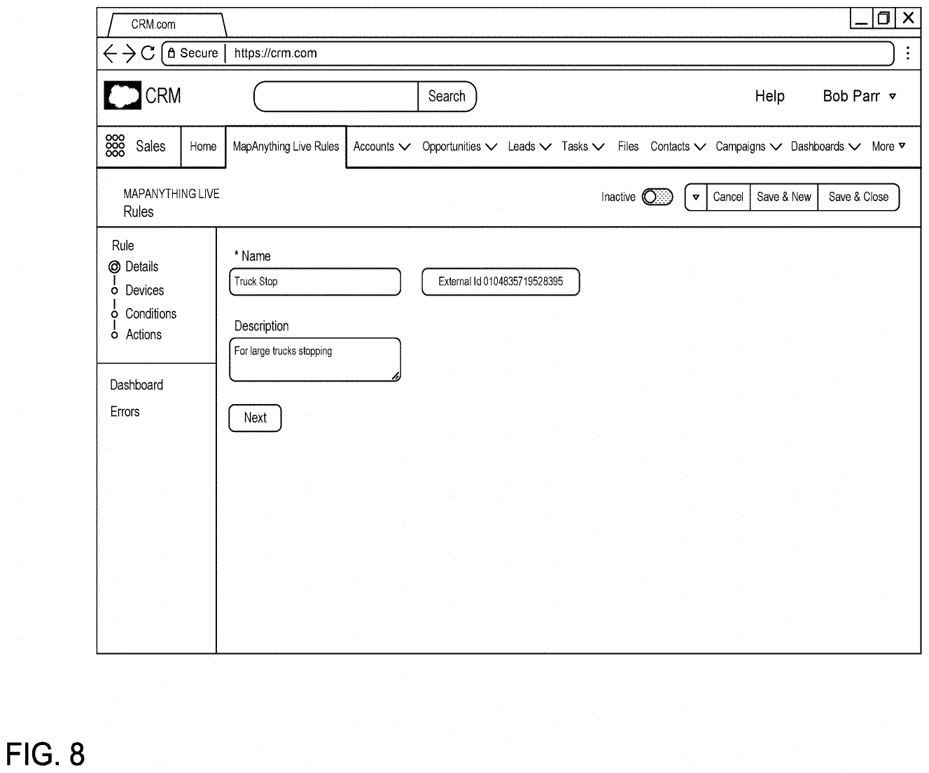

FIG. 7 illustrates a details pane 614 of the new rule creation interface 612 which allows a user to specify a name and description for a new rule. The details pane 614 includes information regarding an external identifier that is used for the rule in the geospatial rules-based computer system or the CRM computer system. A user can provide a name and description for a new rule, as illustrated in FIG. 8.

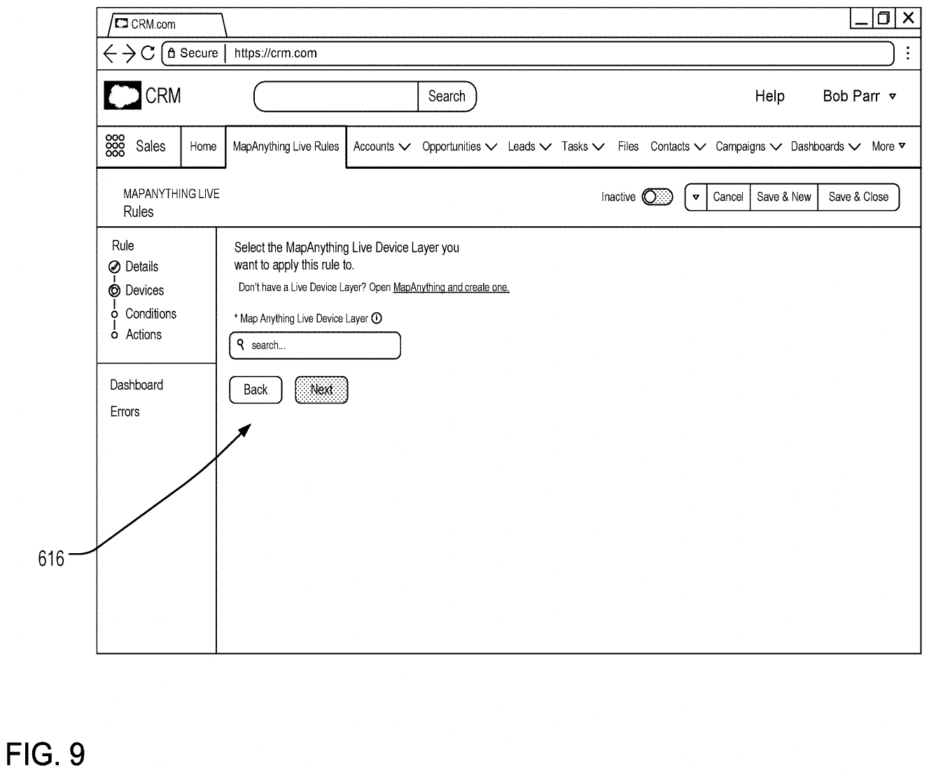

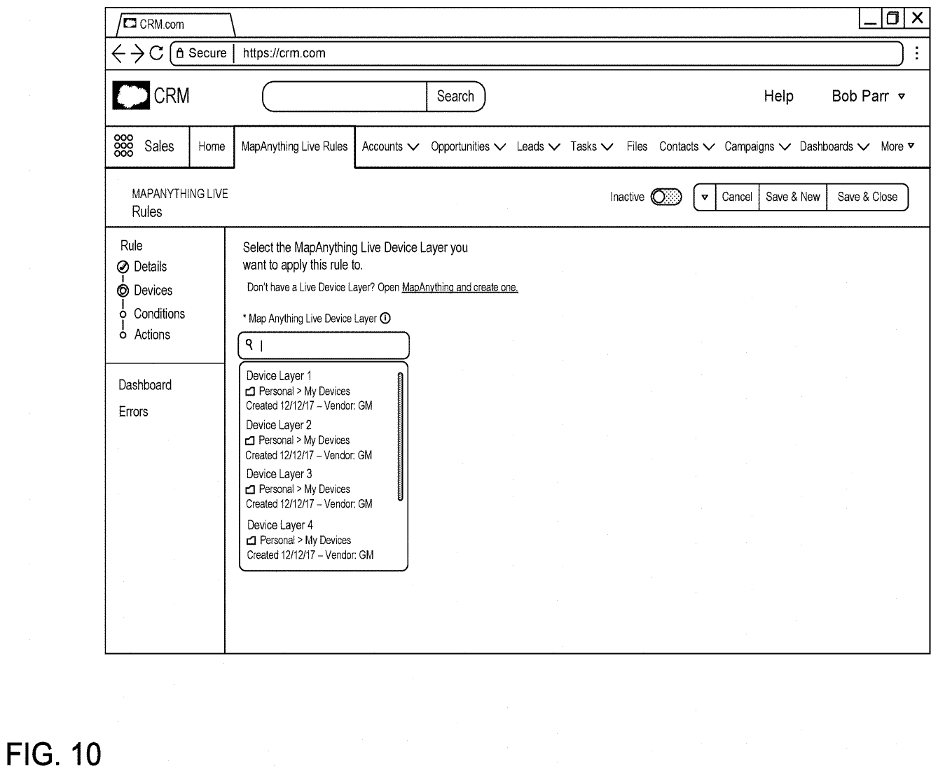

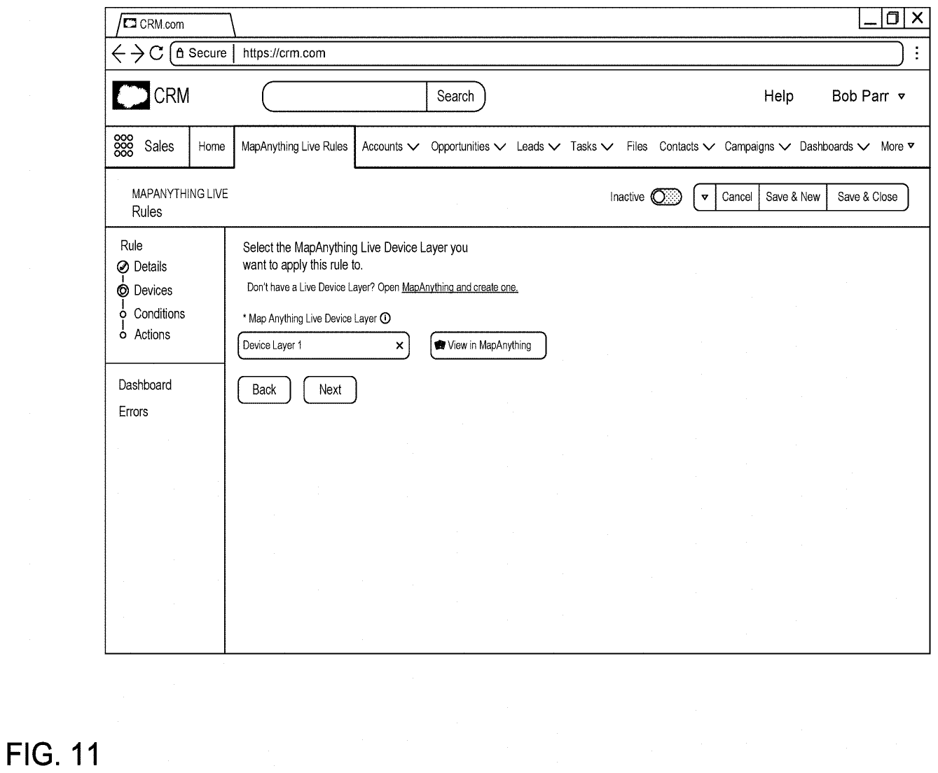

Once a user has done so, the user can advance to a devices pane of the new rule creation interface 612. FIG. 9 illustrates a devices pane 616 of the new rule creation interface 612 which allows a user to specify a device layer to apply the rule to. A device layer is a map layer that is defined to include devices meeting certain user-specified conditions. In accordance with one or more preferred implementations, a user may instead simply apply a rule to all devices associated with the user's account or enterprise. A user can browse available device layers and select one, as illustrated in FIGS. 10-11.

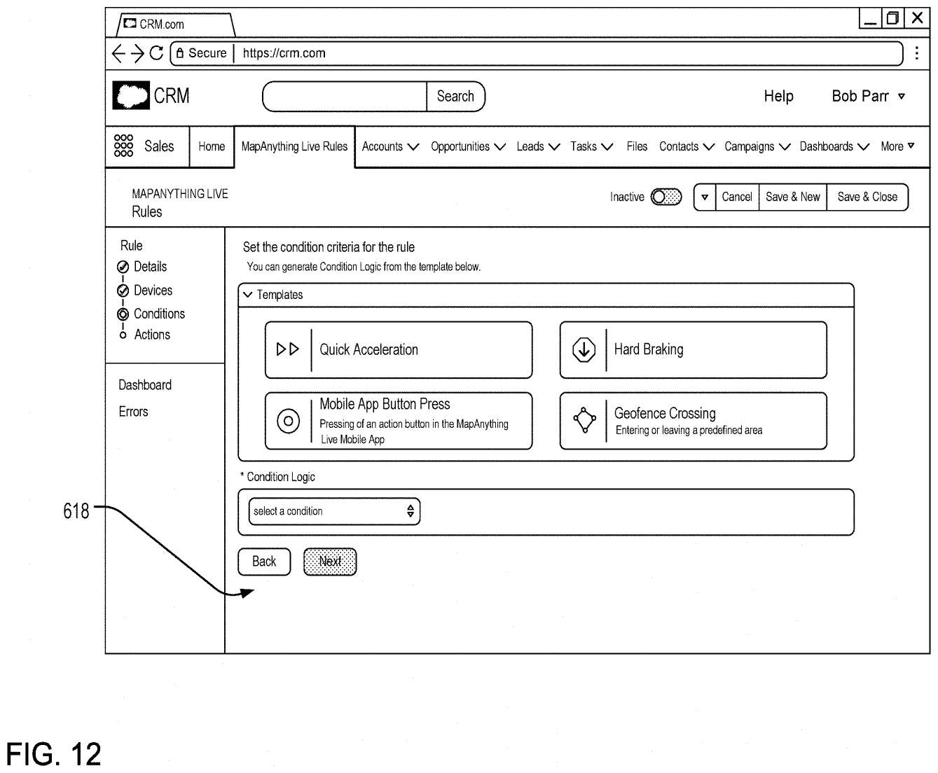

Once a user has done so, the user can advance to a conditions pane of the new rule creation interface 612. FIG. 12 illustrates a conditions pane 618 of the new rule creation interface 612 which allows a user to specify condition logic for a new rule. The conditions pane 618 includes a number of templates that a user can utilize, although in accordance with one or more preferred implementations a user may specify their own conditions without using a template.

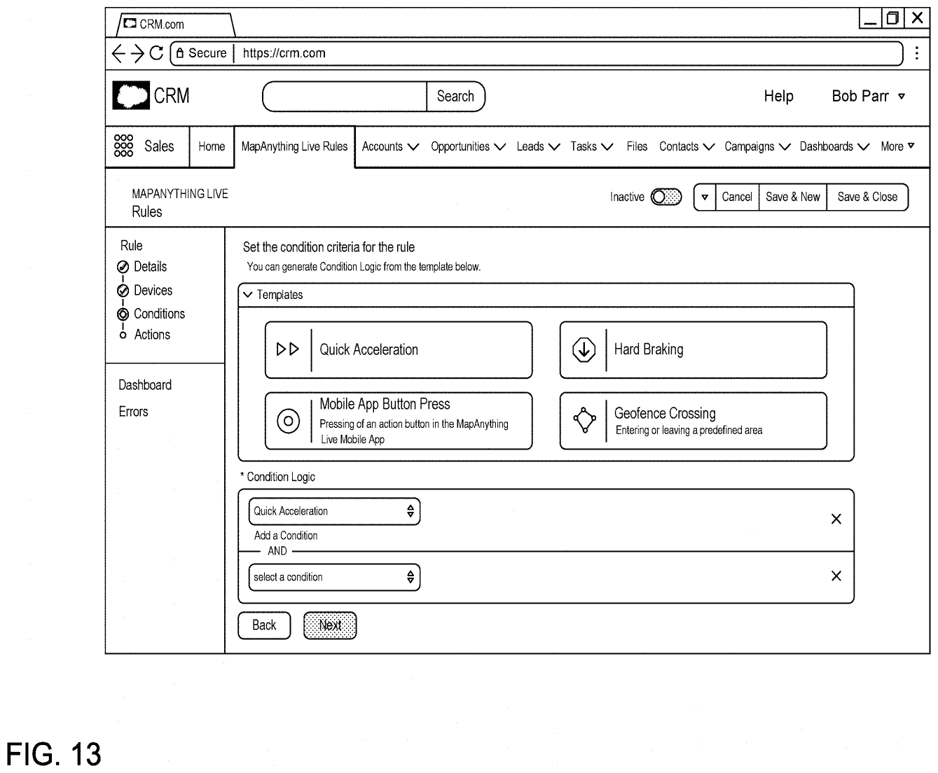

In accordance with one or more preferred implementations, a user may specify multiple conditions linked together by conditional logic (e.g. “AND” or “OR”), as illustrated in FIG. 13.

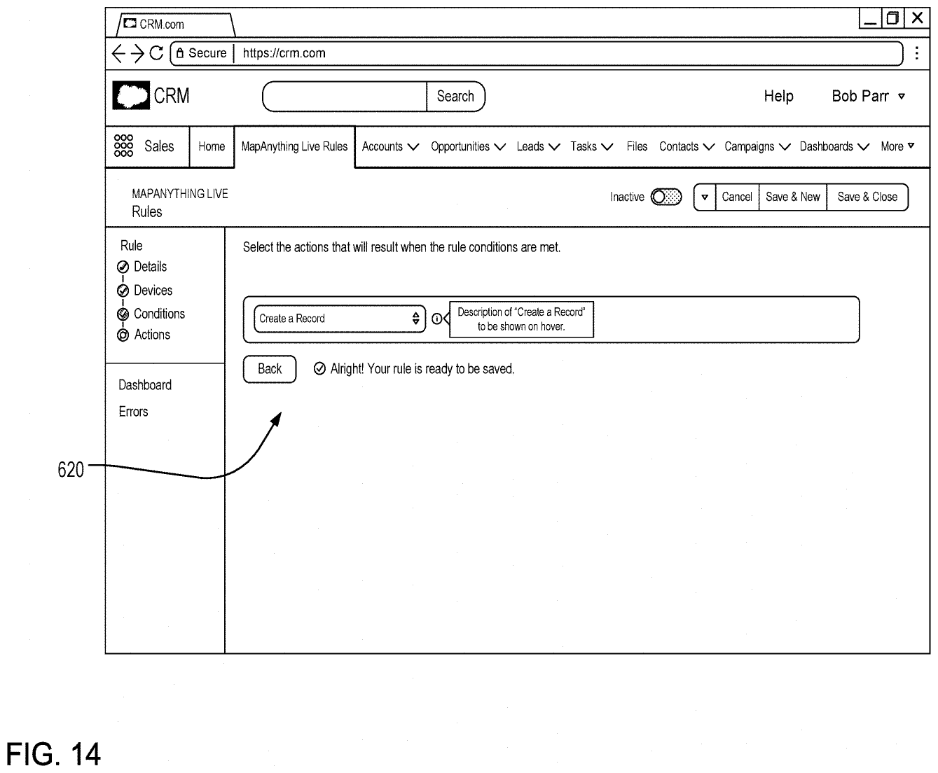

Once a user has specified one or more conditions, a user may advance to an actions pane of the new rule creation interface 612. FIG. 14 illustrates an actions pane 620 of the new rule creation interface 612 which allows a user to specify actions to be taken if the specified conditions are met. In FIG. 14, a user has specified that a “Create a Record” action is to be performed if the defined conditions of the new rule are met for a device belong to the specified device layer.

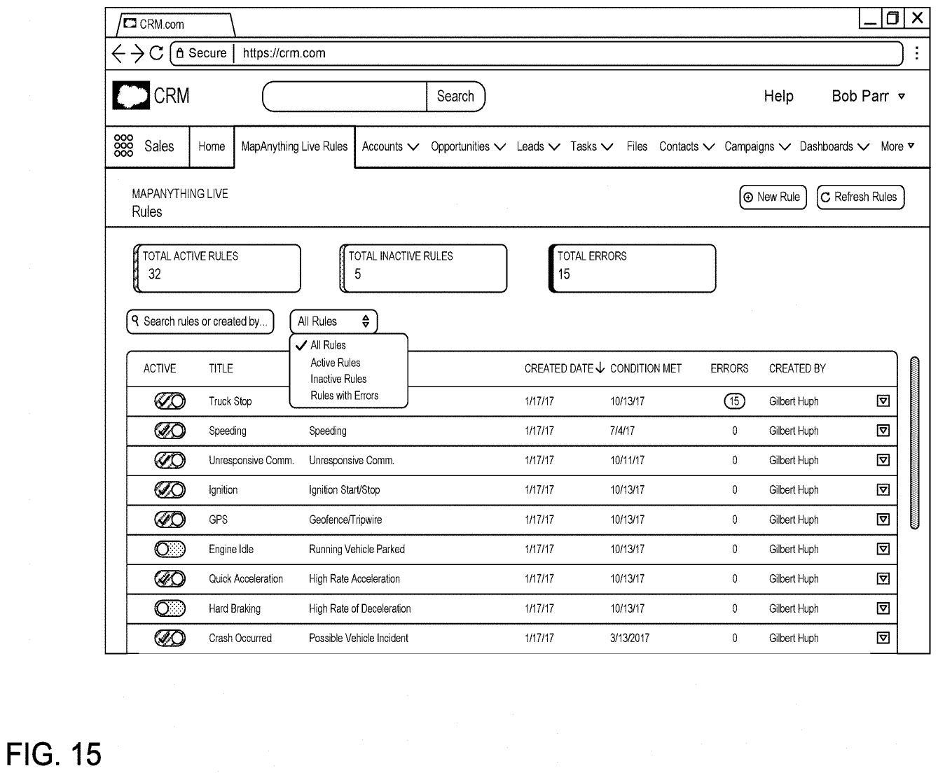

Returning to the Rules Dashboard 604, as noted above, the Rules Dashboard 604 includes a plurality of rows 606 each corresponding to a listing for a rule, and allows a user to filter the displayed rules, or search existing rules. FIG. 15 illustrates use of a dropdown user interface input element to select whether to filter the displayed rules to only display active rules, inactive rules, rules with errors, or to display all rules.

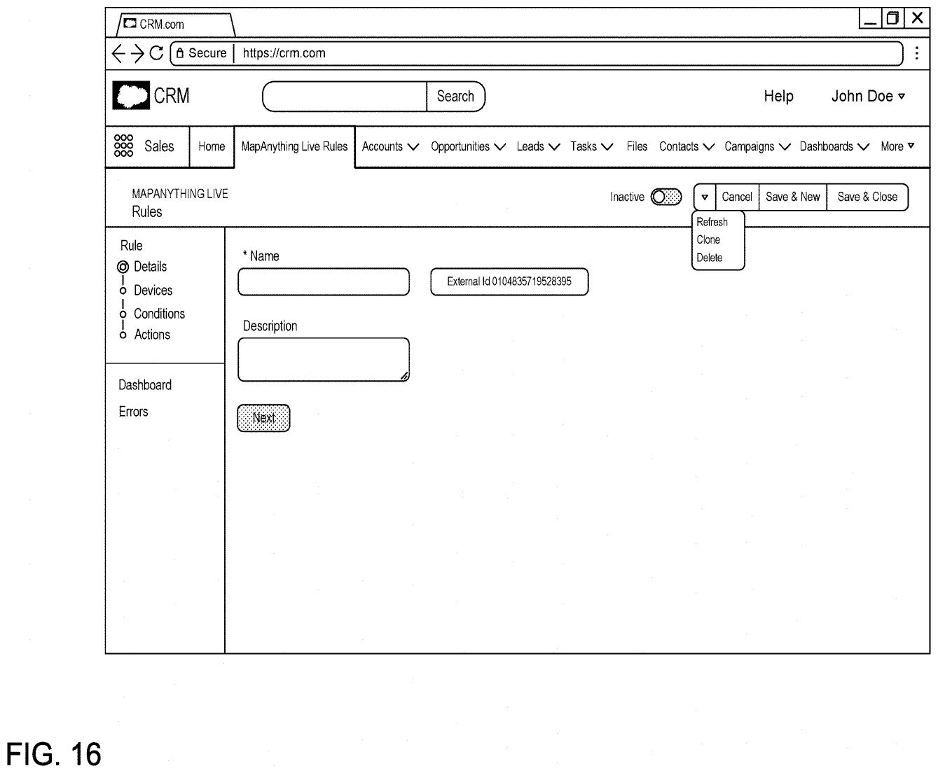

As noted above, each row of the Rules Dashboard 604 preferably includes a user interface element 609 which allows a user to edit, clone, or delete the corresponding rule. In accordance with one or more preferred implementations, a user can similarly edit, clone, or delete a rule from other interfaces, e.g. an interface providing information regarding a single rule, as illustrated in FIG. 16.

### Exemplary Dashboard Reports Based on User-Defined Rules

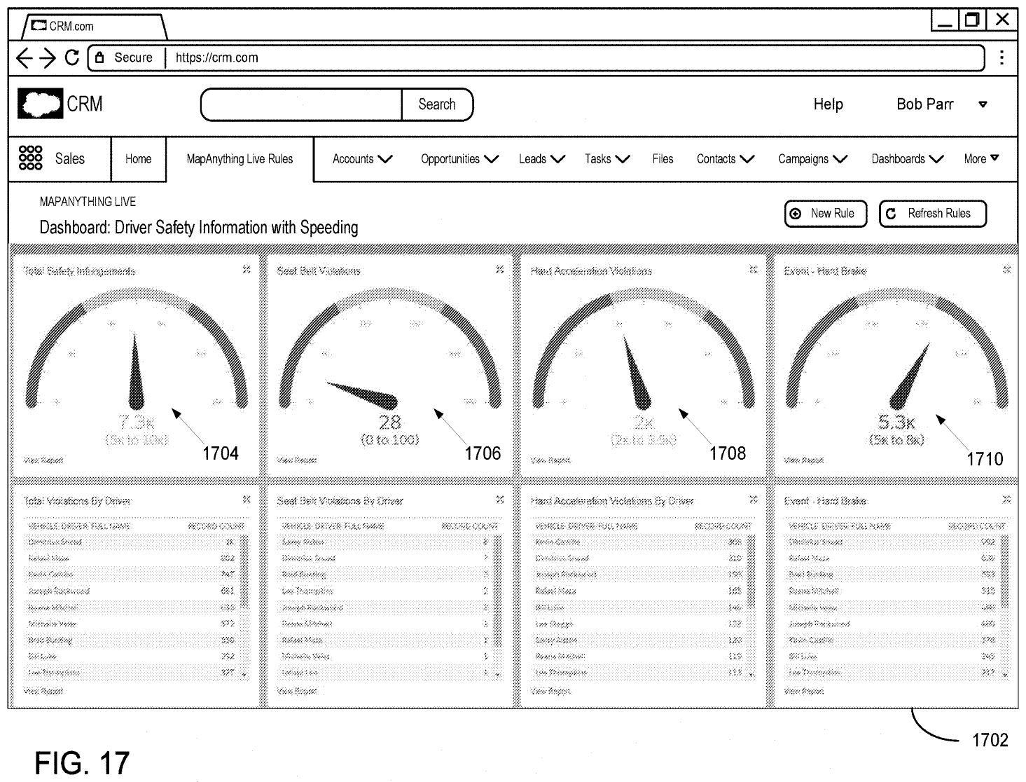

With reference to FIGS. 17-19, a web browser 1702 is illustrated in which GUIs display various dashboard reports based on connected device data processed using user-defined rules.

Specifically. FIG. 17 illustrates a web browser 1702 in which a dashboard is illustrated that relates to driver safety, including speeding. The dashboard includes: a gauge 1704 for visually indicating a total number of safety infringements: a gauge 1706 for visually indicating a total number of seat belt violations; a gauge 1708 for visually indicating a total number of hard acceleration: a gauge 1710 for visually indicating a total number of hard brake violations.

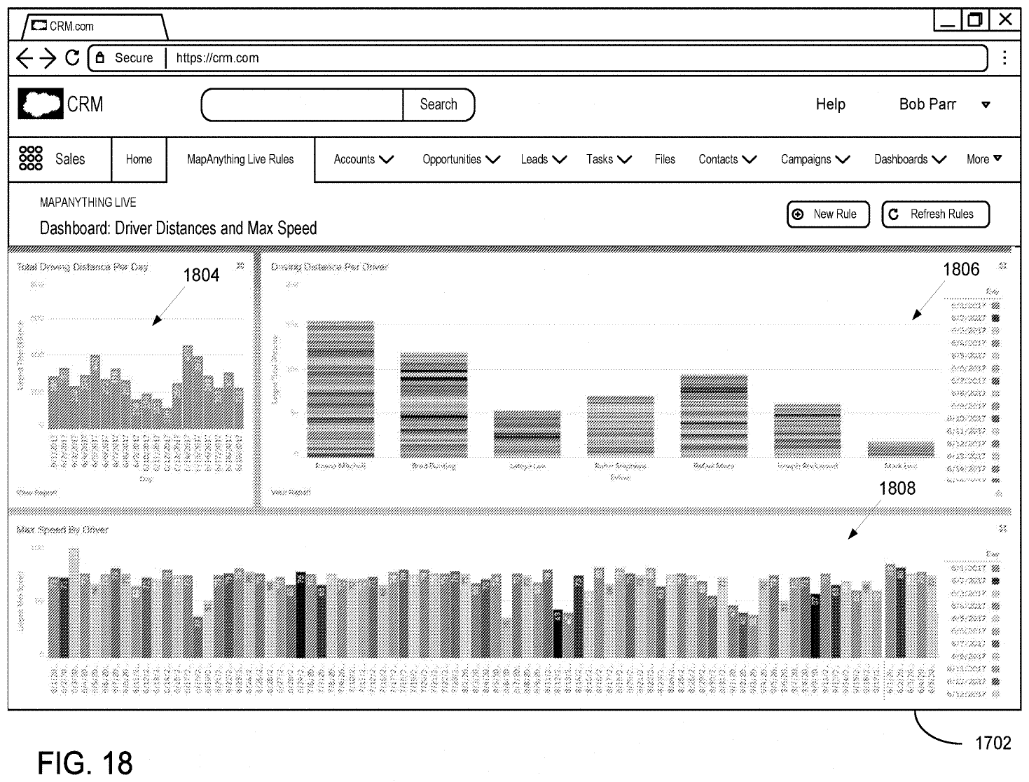

FIG. 18 illustrates the web browser 1702 in which a dashboard is illustrated that relates to driver distances and maximums speeds. The dashboard includes: a graph 1804 for visually indicating a total distance driven per day; another graph 1806 for visually indicating a total distance driven per driver over a period of days; and a graph 1808 for visually indicating a maximum speed of each driver and the particular day thereof for the given period of days.

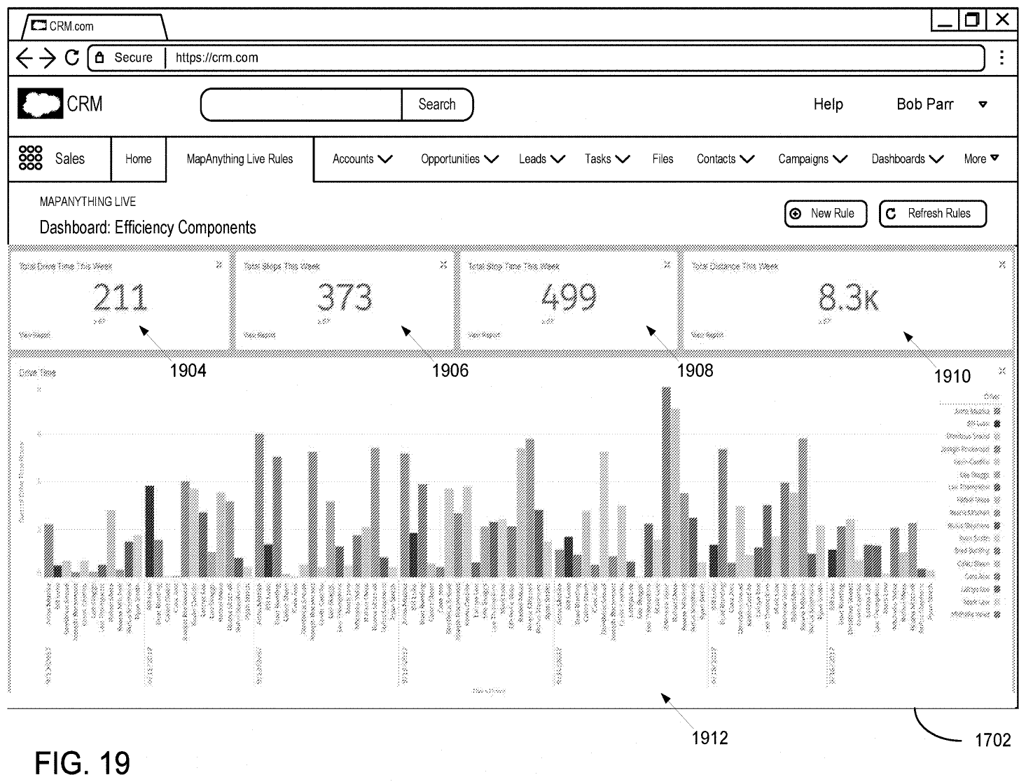

1 FIG. 19 illustrates the web browser 1702 in which a dashboard is illustrated that relates to efficiency. This dashboard visually indicates at 1904 a total number of hours driven for the week; visually indicates at 1906 a total number of stops for the week: visually indicates at 1908 a total stop time for the week; and visually indicates at 1910 a total distance for the week. The dashboard also includes a graph 1912 for visually indicating the drive time for each driver over the week.

The records including the data for these dashboards preferably is automatically inserted as a result of user-defined rules created in accordance with one or more aspects and features of the invention.

### Preferred Commercial Implementation Utilizing Amazon Web Services

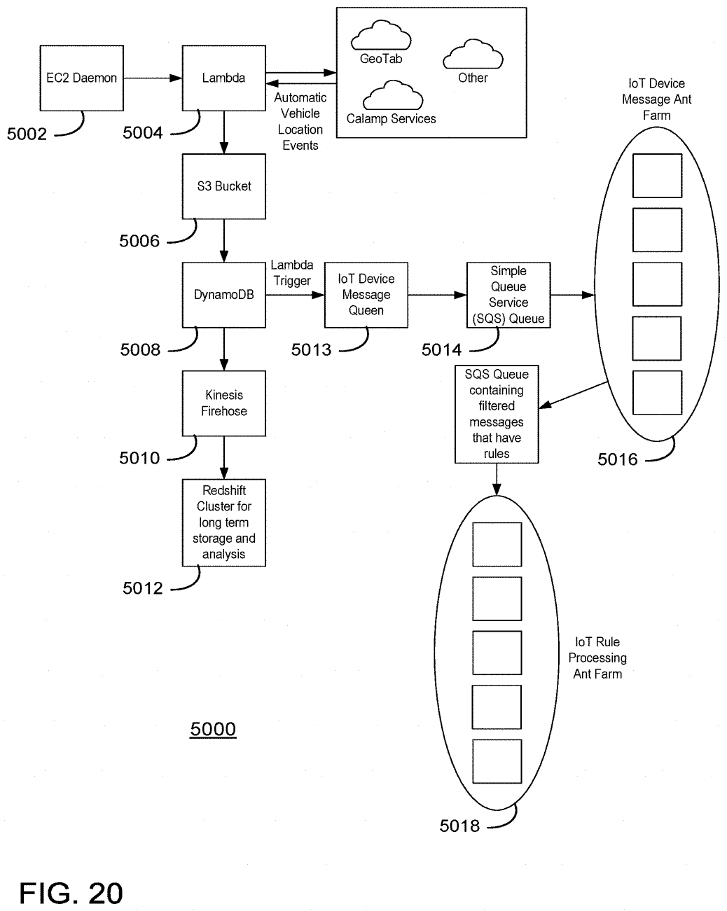

FIG. 20 illustrates exemplary technology for implementing systems and methods in accordance with one or more preferred implementations. Such exemplary technology may be utilized as part of a technology stack 5000 as illustrated in FIG. 20. The illustrated stack 5000 takes advantage of web services currently offered by Amazon Web Services, Inc. The stack 5000 comprises an EC2 Daemon 5002; a Lambda compute service 5004; an S3 bucket 5006; DynamoDB 5008; Kinesis Firehose 5010; a Redshift Cluster 5012; an IoT Device Message Queen 5013: one or more Simple Queue Service (SQS) queues 5014; an Internet of Things (IoT) device message ant farm 5016: and, an IoT rule processing ant farm 5018.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A computer-implemented method comprising:
causing display, on a display device of a user of an application or service implemented within an on-demand computing services environment, of a user interface comprising one or more graphical controls configurable to allow the user to specify:
geographical boundaries, and
rules corresponding to the geographical boundaries, each rule specifying a configurable action to occur, upon traversal of a corresponding geographical boundary by a connected device of an entity, in relation to a database record associated with the application or service;
processing a specification from the user, via the user interface, of a first geographical boundary and a first rule corresponding to the first geographical boundary;
determining that the first geographical boundary has been traversed by a first connected device of a first entity; and
responsive to determining that the first geographical boundary has been traversed by the first connected device, causing an action to occur in relation to the database record associated with the application or service.

2. The method of claim 1, wherein the first entity is a sales representative affiliated with a first organization, the method further comprising:
responsive to determining that the first geographical boundary has been traversed by the first connected device, providing, to a manager of the first entity, an electronic communication regarding a deviation from an assigned route by the first entity.

3. The method of claim 2, wherein the traversal of the first geographical boundary comprises a noncompliance with regulations of the first organization.

4. The method of claim 3, further comprising:
automatically generating a report comprising activity information associated with the first entity, the activity information including mileage traveled by the first entity and hours worked by the first entity, and
providing the report to the manager of the first entity.

5. The method of claim 4, wherein the first connected device comprises a telematic device attached to a vehicle with the first entity.

6. The method of claim 1, wherein the one or more graphical controls allow the user to specify the geographical boundary by drawing on a map.

7. The method of claim 1, wherein the one or more graphical controls allow the user to specify the geofence by specifying a geometric shape on a map.

8. The method of claim 1, wherein the one or more graphical controls allow the user to specify the geofence by specifying a route on a map.

9. The method of claim 1, wherein the one or more graphical controls allow the user to specify the geofence by specifying a tripwire on a map.

10. The method of claim 1, wherein the one or more graphical controls allow the user to specify the geofence by specifying a polygon on a map.

11. A database system implemented using a server system, the database system being configurable to cause:
displaying, on a display device of a user of an application or service implemented within an on-demand computing services environment, of a user interface comprising one or more graphical controls configurable to allow the user to specify:
geographical boundaries, and
rules corresponding to the geographical boundaries, each rule specifying a configurable action to occur, upon traversal of a corresponding geographical boundary by a connected device of an entity, in relation to a database record associated with the application or service;
processing a specification from the user, via the user interface, of a first geographical boundary and a first rule corresponding to the first geographical boundary;
determining that the first geographical boundary has been traversed by a first connected device of a first entity; and
responsive to determining that the first geographical boundary has been traversed by the first connected device, causing an action to occur in relation to the database record associated with the application or service.

12. The database system of claim 11, wherein the first entity is a sales representative affiliated with a first organization, the database system further configurable to cause:
responsive to determining that the first geographical boundary has been traversed by the first connected device, providing, to a manager of the first entity, an electronic communication regarding a deviation from an assigned route by the first entity.

13. The database system of claim 12, wherein the traversal of the first geographical boundary comprises a noncompliance with regulations of the first organization.

14. The database system of claim 13, the database system further configurable to cause:
automatically generating a report comprising activity information associated with the first entity, the activity information including mileage traveled by the first entity and hours worked by the first entity; and
providing the report to the manager of the first entity.

15. The database system of claim 14, wherein the first connected device comprises a telematic device attached to a vehicle with the first entity.

16. A non-transitory computer-readable medium comprising computer-readable program code to be executed by one or more processors when retrieved from the non-transitory computer-readable medium, the program code including instructions configurable to cause:
displaying, on a display device of a user of an application or service implemented within an on-demand computing services environment, of a user interface comprising one or more graphical controls configurable to allow the user to specify:
geographical boundaries, and
rules corresponding to the geographical boundaries, each rule specifying a configurable action to occur, upon traversal of a corresponding geographical boundary by a connected device of an entity, in relation to a database record associated with the application or service;
processing a specification from the user, via the user interface, of a first geographical boundary and a first rule corresponding to the first geographical boundary;
determining that the first geographical boundary has been traversed by a first connected device of a first entity; and
responsive to determining that the first geographical boundary has been traversed by the first connected device, causing an action to occur in relation to the database record associated with the application or service.

17. The non-transitory computer-readable medium of claim 16, wherein the first entity is a sales representative affiliated with a first organization, the instructions further configurable to cause:
responsive to determining that the first geographical boundary has been traversed by the first connected device, providing, to a manager of the first entity, an electronic communication regarding a deviation from an assigned route by the first entity.

18. The non-transitory computer-readable medium of claim 17, wherein the traversal of the first geographical boundary comprises a noncompliance with regulations of the first organization.

19. The non-transitory computer-readable medium of claim 18, the instructions further configurable to cause:
automatically generating a report comprising activity information associated with the first entity, the activity information including mileage traveled by the first entity and hours worked by the first entity, and
providing the report to the manager of the first entity.

20. The non-transitory computer-readable medium of claim 19, wherein the first connected device comprises a telematic device attached to a vehicle with the first entity.
